(19) United States
(12) Patent Application Publication
(10) Pub. No.: US 2025/0247797 A1
(43) Pub. Date: Jul. 31, 2025

(54) METHOD AND APPARATUS FOR UPLINK POWER CONTROL IN A WIRELESS COMMUNICATION SYSTEM

(71) Applicant: ASUS Technology Licensing Inc., Taipei City (TW)

(72) Inventors: Chun-Wei Huang, Taipei City (TW); Yu-Hsuan Guo, Taipei City (TW); Yi-Hsuan Kung, Taipei City (TW)

(21) Appl. No.: 19/036,957

(22) Filed: Jan. 24, 2025

Related U.S. Application Data
(60) Provisional application No. 63/627,743, filed on Jan. 31, 2024.

(51) Int. Cl. H04W 52/24; H04W 52/14; H04W 52/36; H04W 76/20

(52) U.S. Cl. CPC H04W 52/242; H04W 52/146; H04W 52/365; H04W 76/20

(57) ABSTRACT

Methods, systems, and apparatuses are provided for uplink power control in a wireless communication system, wherein a method of a User Equipment (UE) comprises receiving one or more Transmission Configuration Indicator (TCI) state configurations associated with one or more Bandwidth Parts (BWPs) in a serving cell, receiving a first indication to associate a first plurality of Uplink (UL) channels or signals with the first UL TCI state, determining a first Transmit (TX) power for a first UL channel or signal among the first plurality of UL channels or signals based on at least the first Pathloss (PL) offset value and a first PL estimate determined from a first Pathloss Reference Signal (PL RS) associated with the first UL TCI state, performing a first transmission of the first UL channel or signal based on the determined first TX power, receiving a PL offset signal, determining, in response to the PL offset signal, a second TX power for the first UL channel or signal among the first plurality of UL channels or signals based on at least the second PL offset value and a second PL estimate determined from the first PL RS associated with the first UL TCI state, and performing a second transmission of the first UL channel or signal based on the determined second TX power.

### CROSS-REFERENCE TO RELATED APPLICATIONS

The present Application claims priority to and the benefit of U.S. Provisional Patent Application Ser. No. 63/627,743, filed Jan. 31, 2024, which is fully incorporated herein by reference.

### FIELD

This disclosure generally relates to wireless communication networks and, more particularly, to a method and apparatus for uplink power control in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for uplink power control in a wireless communication system. In various embodiments, a method of a UE comprises receiving one or more Transmission Configuration Indicator (TCI) state configurations associated with one or more Bandwidth Parts (BWPs) in a serving cell, wherein a TCI state configuration, of the one or more TCI state configurations, for a first Uplink (UL) TCI state, comprises a parameter for configuring a first Pathloss (PL) offset value, receiving a first indication to associate a first plurality of UL channels or signals with the first UL TCI state, determining a first Transmit (TX) power for a first UL channel or signal among the first plurality of UL channels or signals based on at least the first PL offset value and a first PL estimate determined from a first Pathloss Reference Signal (PL RS) associated with the first UL TCI state, performing a first transmission of the first UL channel or signal based on the determined first TX power, receiving a PL offset signal, wherein the PL offset signal indicates information of one or more PL offset values comprising at least a second PL offset value and information of one or more TCI states comprising the first UL TCI state, determining, in response to the PL offset signal, a second TX power for the first UL channel or signal among the first plurality of UL channels or signals based on at least the second PL offset value and a second PL estimate determined from the first PL RS associated with the first UL TCI state, and performing a second transmission of the first UL channel or signal based on the determined second TX power.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 6.1.3.28-1: PUSCH Pathloss Reference RS Update MAC CE, from 3GPP TS 38.321 i00.

FIG. 6 is a reproduction of FIG. 6.1.3.47-1: Unified TCI state activation/deactivation MAC CE, from 3GPP TS 38.321 i00.

FIG. 7 is a reproduction of FIG. 6.1.3.60-1: Serving Cell Set based SRS TCI State Indication MAC CE, from 3GPP TS 38.321 i00.

FIG. 8 is a reproduction of FIG. 6.1.3.70-1: Enhanced TCI state activation/deactivation MAC CE for Joint TCI States, from 3GPP TS 38.321 i00.

FIG. 9 is a reproduction of FIG. 6.1.3.71-1: Enhanced TCI state activation/deactivation MAC CE for Separate TCI States, from 3GPP TS 38.321 i00.

FIG. 10 is an example diagram of an issue where a UE is served by TRP1 and TRP2 in the serving cell, and both TRP1 and TRP2 correspond to a DL/UL TRP, in accordance with embodiments of the present invention.

FIG. 11 is an example diagram of an enhanced TCI state activation/deactivation MAC CE for separate TCI states, in accordance with embodiments of the present invention.

FIG. 12 is an example diagram showing t1 corresponds to a timing that the UE receives a new TCI state (de)activation signal, t2 corresponds to a timing that the UE applies the activated TCI state(s) according to the signal, t3 corresponds to a timing that the UE receives a beam management DCI indicating one code-point, t4 corresponds to a timing that the UE transmits ACK in response to the BM DCI, and/or t5 corresponds to a timing that the UE applies indicating TCI state(s) according to the code-point indicated by the BM DCI in t3, in accordance with embodiments of the present invention.

FIG. 13 is a flow diagram of a method of a device/UE in a wireless communication system comprising receiving a configuration associated with a serving cell, receiving a TCI state (de)activation signal, applying an indicated TCI code-point, indicated by a BM DCI, comprising a first DL TCI state, a first UL TCI state, and a second UL TCI state, receiving a (scheduling/activating) DCI from the first TRP, determining a TX power associated with the one or more UL channels/signals/transmissions based on at least a PL RS associated with the second UL TCI state, and performing the one or more UL channels/signals/transmission, in accordance with embodiments of the present invention.

FIG. 14 is a flow diagram of a method of a device/UE in a wireless communication system comprising receiving one or more TCI state configurations associated with one or more BWPs in a serving cell, receiving a first indication to associate a first plurality of UL channels or signals with the first UL TCI state, determining a first TX power for a first UL channel or signal among the first plurality of UL channels or signals based on at least the first PL offset value and a first PL estimate determined from a first PL RS associated with the first UL TCI state, performing a first transmission of the first UL channel or signal based on the determined first TX power, receiving a PL offset signal, determining, in response to the PL offset signal, a second TX power for the first UL channel or signal among the first plurality of UL channels or signals based on at least the second PL offset value and a second PL estimate determined from the first PL RS associated with the first UL TCI state, and performing a second transmission of the first UL channel or signal based on the determined second TX power, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-234007, New WID: NR MIMO Phase 5; [2] 3GPP TS 38.214 i00; [3] 3GPP TS 38.211 i00; [4] 3GPP TS 38.212 i00; [5] 3GPP TS 38.331 100; [6] 3GPP TS 38.321 100; [7] 3GPP TS 38.213 i00; and [8] RAN1 112bis meeting report. The standards and documents listed above are hereby expressly and fully incorporated herein by reference in their entirety.

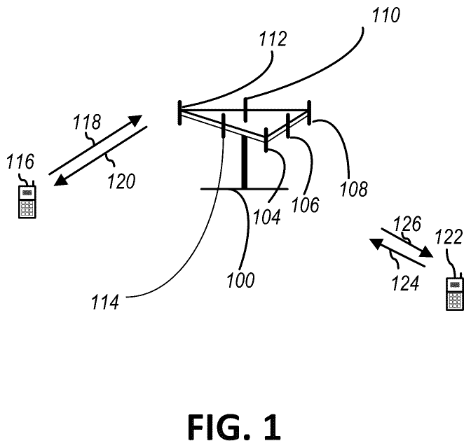

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

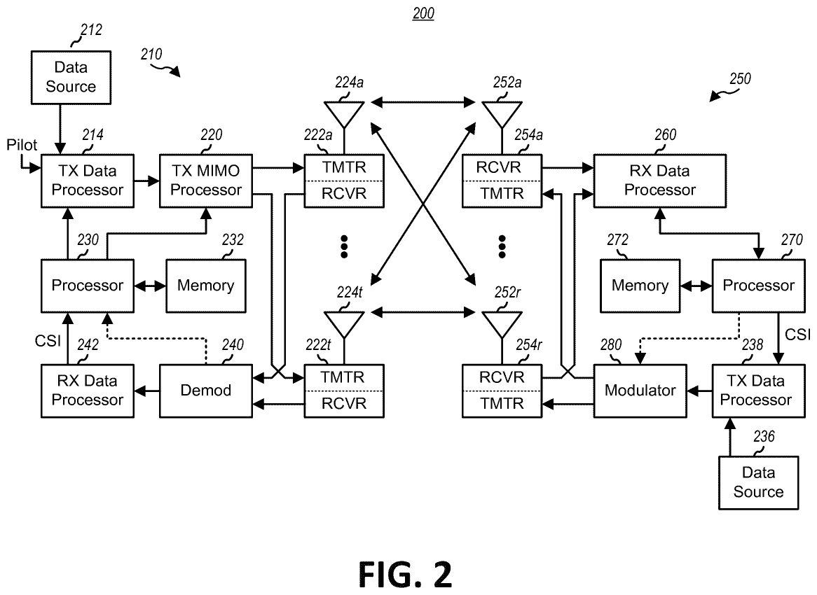

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides NT modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

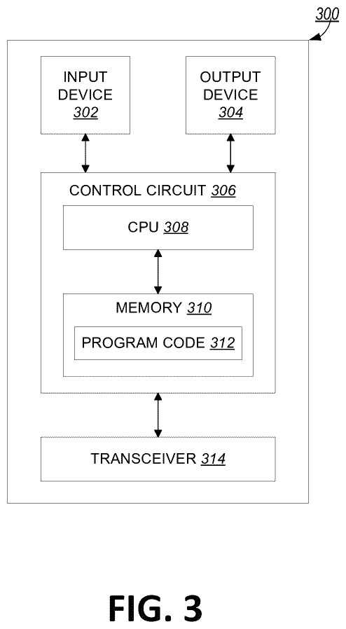

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

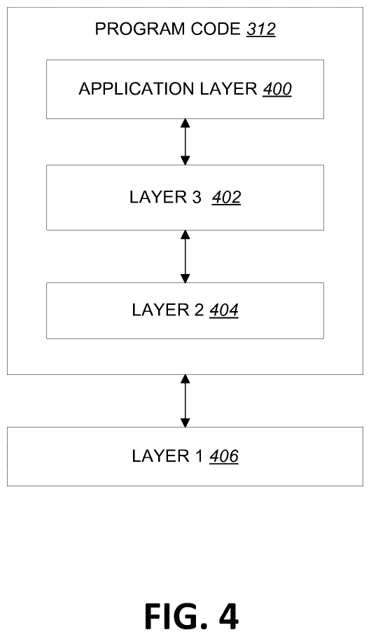

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In [1] RP-234007, New WID: NR MIMO Phase 5, justifications and objectives for MIMO phase are quoted below:

### 3 Justification

Heterogeneous Network can be deployed to improve UL throughput. Since the macro gNB and micro nodes differ in power rating, a UE may receive DL transmission from the macro gNB, but transmit UL to either the macro gNB or non-co-located micro nodes in order to maximize UL throughput. As an option to further reduce energy consumption, the micro nodes can, for instance, reduce or even turn off DL transmissions. To support such deployment scenario, enhancements on UL power control (PC) are needed at least. First, when pathloss RS is transmitted from the macro gNB and the UE transmits UL to the micro nodes, the pathloss measured from the pathloss RS from the macro gNB is not accurate. Therefore, it is necessary to configure the UE with pathloss offset to facilitate accurate calculation of the pathloss associated with the micro nodes. Second, an additional SRS closed-loop PC for DL CSI acquisition to the macro gNB (for DL transmission), separate from that for the SRS to the micro nodes (for UL mTRP reception) should be introduced. Therefore, there is a need for supporting two closed-loop PC adjustment states for SRS, both separate from PUSCH.

### 4 Objective

4.1 Objective of SI or Core part WI or Testing part WI

### The Detailed Objectives are as Follows:

2. Specify enhancement for asymmetric DL sTRP/UL mTRP deployment scenarios, assuming intra-band intra-DU non-co-located mTRP scenarios, without changing existing cell definition or defining a new cell (e.g. UL-only cell), assuming the Rel-17/18 unified TCI framework and fully reusing the legacy QCL/UL spatial relation rules, targeting FR1 and FR2
   a. Two closed-loop PC adjustment states for SRS, both separate from PUSCH; and pathloss offset configurations for pathloss calculation to UL TRP(s), when the pathloss RS is from DL sTRP.

### Acronyms:

STRP: single TRP (transmit-receive point)
mTRP: multiple TRP (transmit-receive point)
   In [2] 3GPP TS 38.214 i00, the Following is Provided:

### 5.1.5 Antenna Ports Quasi Co-Location

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE can be configured with a list of up to 128 TCI-State configurations, within the higher layer parameter dl-OrJointTCI-StateList in PDSCH-Config for providing a reference signal for the quasi co-location for DM-RS of PDSCH and DM-RS of PDCCH in a BWP/CC, for CSI-RS, and to provide a reference, if applicable, for determining UL TX spatial filter for dynamic-grant and configured-grant based PUSCH and PUCCH resource in a BWP/CC, and SRS.

If the TCI-State or TCI-UL-State configurations are absent in a BWP of the CC, the UE can apply the TCI-State or TCI-UL-State configurations from a reference BWP of a reference CC. The UE is not expected to be configured with tci-StatesToAddModList, SpatialRelationInfo or PUCCH-SpatialRelationInfo, except SpatialRelationInfoPos in a CC in a band, if the UE is configured with dl-OrJointTCI-StateList or ul-TCI-StateList in any CC in the same band. The UE can assume that when the UE is configured with tci-StatesToAddModList in any CC in the CC list configured by simultaneousTCI-UpdateList1-r16, simultaneousTCI-UpdateList2-r16, simultaneousSpatial-UpdatedList1-r16, or simultaneousSpatial-UpdatedList2-r16, the UE is not configured with dl-OrJointTCI-StateList or ul-TCI-StateList in any CC within the same band in the CC list.

The UE receives an activation command, as described in clause 6.1.3.xx of [10, TS 38.321], 6.1.3.47 of [10, TS 38.321] or 6.1.4.xx of [10, TS 38.321], used to map up to 8 TCI states and/or pairs of TCI states, with one TCI state for DL channels/signals and/or one TCI state for UL channels/signals to the codepoints of the DCI field ‘Transmission Configuration Indication’ for one or for a set of CCs/DL BWPs, [and/] or up to 8 sets of TCI states, where each set is comprised of up to two TCI state(s) for DL and UL signals/channels, or up to two TCI state(s) for DL channels/signals and up to two TCI state(s) for UL channels/signals to the codepoints of the DCI field ‘Transmission Configuration Indication’ for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. If the activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied as described in [11, TS 38.133].

If a UE receives a higher layer configuration of dl-OrJointTCI-StateList with a single TCI-State, that can be used as an indicated TCI state, the UE obtains the QCL assumptions from the configured TCI state for DM-RS of PDSCH and DM-RS of PDCCH, and the CSI-RS applying the indicated TCI state.

If a UE receives a higher layer configuration of dl-OrJointTCI-StateList with a single TCI-State or ul-TCI-StateList with a single TCI-UL-State, that can be used as an indicated TCI state, the UE determines an UL TX spatial filter, if applicable, from the configured TCI state for dynamic-grant and configured-grant based PUSCH and PUCCH, and SRS applying the indicated TCI state.

When a UE configured with dl-OrJointTCI-StateList would transmit a PUCCH with positive HARQ-ACK or a PUSCH with positive HARQ-ACK corresponding to the DCI carrying the TCI State indication and without DL assignment, or corresponding to the PDSCH scheduled by the DCI carrying the TCI State indication, and if the indicated TCI State(s) is/are different from the previously indicated one(s), the indicated TCI-State(s) and/or TCI-UL-State(s) should be applied starting from the first slot that is at least beamAppTime symbols after the last symbol of the PUCCH or the PUSCH. The first slot and the beamAppTime symbols are both determined on the active BWP with the smallest SCS among the BWP(s) from the CCs applying the indicated TCI-State(s) or TCI-UL-State(s) that are active at the end of the PUCCH or the PUSCH carrying the positive HARQ-ACK.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

### 6 Physical Uplink Shared Channel Related Procedure

### 6.1 UE Procedure for Transmitting the Physical Uplink Shared Channel

PUSCH transmission(s) can be dynamically scheduled by an UL grant in a DCI, or the transmission can correspond to a configured grant Type 1 or Type 2. The configured grant Type 1 PUSCH transmission is semi-statically configured to operate upon the reception of higher layer parameter of configuredGrantConfig including rrc-ConfiguredUplinkGrant without the detection of an UL grant in a DCI. The configured grant Type 2 PUSCH transmission is semi-persistently scheduled by an UL grant in a valid activation DCI according to clause 10.2 of [6, TS 38.213] after the reception of higher layer parameter configuredGrantConfig not including rrc-ConfiguredUplinkGrant. If configuredGrantConfigToAddModList is configured, more than one configured grant configuration of configured grant Type 1 and/or configured grant Type 2 may be active at the same time on an active BWP of a serving cell.

The UE can be configured with a list of up to 64 TCI-UL-State configurations within the higher layer parameter BWP-UplinkDedicated. Each TCI-UL-State configuration contains a parameter for configuring one reference signal, if applicable, for determining UL TX spatial filter for dynamic-grant and configured-grant based PUSCH and PUCCH resource in a CC, and SRS.

When the UE is configured dl-OrJointTCI-StateList or ul-TCI-StateList, the UE shall perform PUSCH transmission corresponding to a Type 1 configured grant or a Type 2 configured grant or a dynamic grant according to the spatial relation, if applicable, with a reference to the RS for determining UL Tx spatial filter. The RS is determined based on an RS configured with qcl-Type set to ‘typeD’ of the indicated TCI-State or an RS in the indicated TCI-UL-State. The reference RS in the indicated TCI-State can be a CSI-RS resource in a NZP-CSI-RS-ResourceSet configured with higher layer parameter repetition, or a CSI-RS resource in an NZP-CSI-RS-ResourceSet configured with higher layer parameter trs-Info.

When a UE is configured with dl-OrJointTCI-StateList or TCI-UL-State and is having two indicated TCI-States or TCI-UL-States,
a UE having a PUSCH transmission scheduled or activated by DCI format 0_0 should apply the first indicated TCI state to the PUSCH transmission,
a UE configured with a PUSCH transmission corresponding to a Type 1 configured grant is expected to be configured with the higher layer parameter applyIndicatedTCIState indicating the first, the second or both of the indicated TCI states to be applied for the PUSCH transmission. If ‘both’ TCI states are indicated, the UE should apply the first indicated TCI state to the PUSCH transmission occasion(s) or the PUSCH antenna port(s) associated with the first SRS resource set for CB/NCB transmission, and the second indicated TCI state to the PUSCH transmission occasion(s) or the PUSCH antenna port(s) associated with the second SRS resource set for CB/NCB transmission; otherwise the UE should apply either the ‘first’ or ‘second’ indicated TCI state to all PUSCH transmission occasions.

In [3] 3GPP TS 38.211 i00, relevant paragraphs are quoted below:

### 4.4 Physical Resources

### 4.4.1 Antenna Ports

An antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

In [4] 3GPP TS 38.212 i00, relevant paragraphs are quoted below:

### 7.3.1.1.2 Format 0_1

DCI format 0_1 is used for the scheduling of one or multiple PUSCH in one cell, or indicating CG downlink feedback information (CG-DFI) to a UE.

The following information is transmitted by means of the DCI format 0_1 with CRC scrambled by C-RNTI or CS-RNTI or SP-CSI-RNTI or MCS-C-RNTI:
Bandwidth part indicator-0, 1 or 2 bits as determined by the number of UL BWPs n_{BWP,RRC} configured by higher layers, excluding the initial UL bandwidth part. The bitwidth for this field is determined as ┌log₂(n_{BWP})┐ bits, where
   n_{BWP}=n_{BWPRRC}+1 if n_{BWP.RRC}≤3, in which case the bandwidth part indicator is equivalent to the ascending order of the higher layer parameter BWP-Id;
   otherwise n_{BWP}=n_{BWPRRC}, in which case the bandwidth part indicator is defined in Table 7.3.1.1.2-1;
Frequency domain resource assignment-number of bits determined by the following, where N_{RB}^{UL, BWP} is the size of the active UL bandwidth part:
Time domain resource assignment—0, 1, 2, 3, 4, 5, or 6 bits
SRS resource set indicator—0 or 2 bits
   2 bits according to Table 7.3.1.1.2-36 if
      txConfig=nonCodeBook, and there are two SRS resource sets configured by srs-ResourceSetToAddModList and associated with the usage of value ‘nonCodeBook’, and is not configured with coresetPoolIndex or the value of coresetPoolIndex is the same for all CORESETs if coresetPoolIndex is provided, or
      txConfig=codebook, and there are two SRS resource sets configured by srs-ResourceSetToAddModList and associated with usage of value ‘codebook’, and is not configured with coresetPoolIndex or the value of coresetPoolIndex is the same for all CORESETs if coresetPoolIndex is provided;
   0 bit otherwise.
SRS resource indicator-number of bits determined by the following:
Second SRS resource indicator-number of bits determined by the following:

TABLE 7.3.1.1.2-36
SRS resource set indication

| Bit field | |
|---|---|
| mapped to | |
| index | SRS resource set indication |
| 0 | If there are two indicated joint/UL TCI states, the first indicated joint/UL TCI state |
| | is applied to the corresponding PUSCH transmission occasions. |
| 1 | If there are two indicated joint/UL TCI states, the second indicated joint/UL TCI |
| | state is applied to the corresponding PUSCH transmission occasions. |
| 2 | If there are two indicated joint/UL TCI states, the first indicated joint/UL TCI state |
| | is applied to the PUSCH transmission occasions/antenna ports associated with |
| | the first SRS resource set, and the second indicated joint/UL TCI state is applied |
| | to the PUSCH transmission occasions/antenna ports associated with the second |
| | SRS resource set. |
| 3 | If there are two indicated joint/UL TCI states, the first indicated joint/UL TCI state |
| | is applied to the PUSCH transmission occasions associated with the first SRS |
| | resource set, and the second indicated joint/UL TCI state is applied to the PUSCH |
| | transmission occasions associated with the second SRS resource set. |
| | If multipanelScheme is configured, this row is reserved.. |

NOTE 1:
The first and the second SRS resource sets are respectively the ones with lower and higher srs-ResourceSetId of the two SRS resources sets configured by higher layer parameter srs-ResourceSetToAddModList or srs-ResourceSetToAddModListDCI-0-2, and associated with the higher layer parameter usage of value ‘nonCodeBook’ if txConfig = nonCodebook or ‘codebook’ if txConfig = codebook. . . .

### 7.3.1.2.2 Format 1_1

DCI format 1_1 is used for the scheduling of one or multiple PDSCH in one cell.

The following information is transmitted by means of the DCI format 1_1 with CRC scrambled by C-RNTI or CS-RNTI or MCS-C-RNTI:
Bandwidth part indicator—0, 1 or 2 bits as determined by the number of DL BWPS n_{BWP.RRC} configured by higher layers, excluding the initial DL bandwidth part. The bitwidth for this field is determined as ┌log₂(n_{BWP})┐ bits, where
Frequency domain resource assignment-number of bits determined by the following, where N_{RB}^{DL,BWP} is the size of the active DL bandwidth part:
Time domain resource assignment—0, 1, 2, 3, 4, 5 or 6 bits
Transmission configuration indication—0 bit if higher layer parameter tci-PresentInDCI is not enabled; otherwise 3 bits as defined in Clause 5.1.5 of [6, TS38.214].
TCI selection—0 bit if higher layer parameter tciSelection-PresentInDCI is not configured; otherwise 2 bits according to Table 7.3.1.2.2-11.

TABLE 7.3.1.2.2-11
TCI selection

| Bit field | |
|---|---|
| mapped to | |
| index | TCI selection |
| 0 | The first indicated joint/DL TCI state is applied to the |
| | scheduled PDSCH |
| 1 | The second indicated joint/DL TCI state is applied to the |
| | scheduled PDSCH |
| 2 | Both indicated joint/DL TCI states are applied to the |
| | scheduled PDSCH |
| 3 | Reserved |

In [5] 3GPP TS 38.331 100, relevant information element (IE) and parameters are quoted below

### BWP-UplinkDedicated

The IE BWP-UplinkDedicated is used to configure the dedicated (UE specific) parameters of an uplink BWP.

### BWP-UplinkDedicated Information Element

| BWP-UplinkDedicated ::= | | SEQUENCE { |
|---|---|---|
| | pucch-Config | SetupRelease { PUCCH-Config } |
| OPTIONAL, | -- Need M | |
| | pusch-Config | SetupRelease { PUSCH-Config } |
| OPTIONAL, | -- Need M | |
| | configuredGrantConfig | SetupRelease { ConfiguredGrantConfig } |
| OPTIONAL, | -- Need M | |
| | srs-Config | SetupRelease { SRS-Config } |
| OPTIONAL, | -- Need M | |
| ... | ]], | |
| | [[ | |
| | ul-TCI-StateList-r17 | CHOICE { |
| | explicitlist | SEQUENCE { |
| | ul-TCI-ToAddModList-r17 | SEQUENCE (SIZE (1..maxUL-TCI-r17)) OF TCI-UL-State- |
| r17 | OPTIONAL, -- Need N | |
| | ul-TCI-ToReleaseList-r17 | SEQUENCE (SIZE (1..maxUL-TCI-r17)) OF TCI-UL-StateId- |
| r17 | OPTIONAL -- Need N | |
| | }, | |
| | unifiedTCI-StateRef-r17 | ServingCellAndBWP-Id-r17 |
| | } | |
| OPTIONAL, | -- Need R | |
| | ul-powerControl-r17 | Uplink-powerControlId-r17 |
| OPTIONAL, | -- Cond NoTCI-PC | |
| | pathlossReferenceRSToAddModList-r17 | SEQUENCE (SIZE (1..maxNrofPathlossReferenceRSs-r17)) OF |

PathlossReferenceRS-r17

| OPTIONAL, | -- Need N | |
|---|---|---|
| | pathlossReferenceRSToReleaseList-r17 | SEQUENCE (SIZE (1..maxNrofPathlossReferenceRSs-r17)) OF |

PathlossReferenceRS-Id-r17

| | |
|---|---|
| OPTIONAL | -- Need N |
| | ]] |

}

BWP-UplinkDedicated field descriptions

. . .
configuredGrantConfig
A Configured-Grant of type1 or type2. It may be configured for UL or SUL but in case of type1 not for both at a time. . . .
configuredGrantConfigToAddModList
Indicates a list of one or more configured grant configurations to be added or modified for one BWP. . . .
configuredGrantConfigToReleaseList
Indicates a list of one or more UL Configured Grant configurations to be released. The NW may release a configured
grant configuration at any time.
. . .
pathlossReferenceRSToAddModList
A list of Reference Signals (e.g. a CSI-RS config or a SS block) to be used for path loss estimation for PUSCH, PUCCH
and SRS for unified TCI state operation. If unifiedTCI-StateType is not configured for the serving cell, no element in this
list is configured.
. . .
pusch-Config
PUSCH configuration for one BWP of the normal UL or SUL of a serving cell. If the UE is configured with SUL and if it
has a PUSCH-Config for both UL and SUL, an UL/SUL indicator field in DCI indicates which of the two to use. See TS
38.212 [17], clause 7.3.1.
. . .
srs-Config
Uplink sounding reference signal configuration.
ul-powerControl
Configures power control parameters for PUCCH, PUSCH and SRS when UE is configured with unifiedTCI-StateType
for this serving cell. For each serving cell, ul-powerControl is either configured in all BWP-UplinkDedicated or it is not
configured in any BWP-UplinkDedicated. When unifiedTCI-StateRef in the BWP-UplinkDedicated or in the PDSCH-
Config if the unifiedTCI-StateType is set to joint, of a serving cell refers to another serving cell, ul-powerControl is either
configured in all BWP-UplinkDedicated of these two serving cells or it is not configured in any BWP-UplinkDedicated of
these two serving cells.
ul-TCI-StateList
Indicates the applicable UL TCI states for PUCCH, PUSCH and SRS.
ul-TCI-ToAddModList
Indicates a list of UL TCI states.
unifiedTCI-StateRef
Provides the serving cell and UL BWP where UL TCI states applicable to this UL BWP are defined. The value of
unifiedTCI-StateType of current serving cell is the same in the serving cell indicated by unifiedTCI-StateRef.

### TCI-State

The IE TCI-State associates one or two DL reference signals with a corresponding quasi-colocation (QCL) type.

### TCI-State Information Element

| | |
|---|---|
| TCI-State ::= | SEQUENCE { |
| tci-StateId | TCI-StateId, |
| qcl-Type1 | QCL-Info, |
| qcl-Type2 | QCL-Info |

| | |
|---|---|
| OPTIONAL, | -- Need R |

```
  ...,
  [[
```

| | |
|---|---|
| additionalPCI-r17 | AdditionalPCIIndex-r17 |

| | |
|---|---|
| OPTIONAL, | -- Need R |

| | |
|---|---|
| pathlossReferenceRS-Id-r17 | PathlossReferenceRS-Id-r17 |

| | |
|---|---|
| OPTIONAL, | -- Cond JointTCI1 |

| | |
|---|---|
| ul-powerControl-r17 | Uplink-powerControlId-r17 |

| | |
|---|---|
| OPTIONAL | -- Cond JointTCI |

```
  ]],
  [[
```

| | |
|---|---|
| tag-Id-ptr-r18 | ENUMERATED {n0,n1} |

| | |
|---|---|
| OPTIONAL | -- Cond 2TA |

]]
}

| | |
|---|---|
| QCL-Info ::= | SEQUENCE { |
| cell | ServCellIndex |

| | |
|---|---|
| OPTIONAL, | -- Need R |

| | |
|---|---|
| bwp-Id | BWP-Id |

| | |
|---|---|
| OPTIONAL, | -- Cond CSI-RS-Indicated |

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

QCL-Info field descriptions

bwp-Id
The DL BWP which the RS is located in. If the field is absent, the RS is located in the DL BWP in which the TCI-State is
applied by the UE.
cell
The UE's serving cell in which the referenceSignal is configured. If the field is absent, the referenceSignal is configured
in the serving cell in which the TCI-State is applied by the UE. The RS can be located on a serving cell other than the
serving cell for which the TCI-State is applied by the UE only if the qcl-Type is configured as typeC or typeD. If the
referenceSignal is set to csi-rs and unifiedTCI-StateType is configured, either both cell and bwp-Id are present or both
cell and bwp-Id are absent. See TS 38.214 [19] clause 5.1.5.
referenceSignal
Reference signal with which quasi-collocation information is provided as specified in TS 38.214 [19] clause 5.1.5.
qcl-Type
QCL type as specified in TS 38.214 [19] clause 5.1.5.

TCI-State field descriptions

. . .
pathlossReferenceRS-Id
The ID of the reference signal (e.g. a CSI-RS or an SS block) used for PUSCH, PUCCH and SRS path loss estimation.
This field refers to an element in the list configured using pathlossReferenceRSToAddModList in the serving cell and UL
BWP where the TCI State is applied by the UE.
qcl-Type1, qcl-Type2
QCL information for the TCI state as specified in TS 38.214 [19] clause 5.1.5.
tag-Id-ptr
It indicates the TAG that is associated with this TCI state, value no means the TCI state associate with the TAG
indicated by tag-Id, value n1 means this TCI state associated with the TAG indicated by tag2-Id. The tag_id_ptr refers to
the TAG of the serving cell where the TCI state is applied.
tci-StateId
ID number of the TCI state.
ul-PowerControl
Configures power control parameters for PUCCH, PUSCH and SRS for this TCI state. The field is present here only if
ul-powerControl is not configured in any BWP-Uplink-Dedicated of this serving cell. This field refers to an element in the
list configured using uplink-PowerControlToAddModList in the serving cell where the dl-OrJointTCI-StateToAddModList
is configured.

### TCI-UL-State

The IE TCI-UL-State indicates the TCI state information for UL transmission.

### TCI-UL-State Information Element

| TCI-UL-State-r17 ::= | SEQUENCE { | |
|---|---|---|
| tci-UL-StateId-r17 | TCI-UL-StateId-r17, | |
| servingCellId-r17 | ServCellIndex | OPTIONAL, |

-- Need R

| | | |
|---|---|---|
| bwp-Id-r17 | BWP-Id | OPTIONAL, |

-- Cond CSI-RSorSRS-Indicated

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | | |
|---|---|---|
| additionalPCI-r17 | AdditionalPCIIndex-r17 | OPTIONAL, |

-- Need R

| | | |
|---|---|---|
| ul-powerControl-r17 | Uplink-powerControlId-r17 | OPTIONAL, |

-- Need R

| | | |
|---|---|---|
| pathlossReferenceRS-Id-r17 | PathlossReferenceRS-Id-r17 | OPTIONAL, |

```
-- Cond Mandatory
  ...,
  [[
```

| | | |
|---|---|---|
| tag-Id-ptr-r18 | ENUMERATED {n0,n1} | OPTIONAL |

-- Cond 2TA
]]
}

### Uplink-PowerControl

The IE Uplink-PowerControl is used to configure UE specific power control parameter for PUSCH, PUCCH and SRS.

### Uplink-PowerControl Information Element

| Uplink-powerControl-r17 ::= SEQUENCE { | |
|---|---|
| ul-powercontrolId-r17 | Uplink-powerControlId-r17, |
| p0AlphaSetforPUSCH-r17 | P0AlphaSet-r17 |
| OPTIONAL, -- Need R | |
| p0AlphaSetforPUCCH-r17 | P0AlphaSet-r17 |
| OPTIONAL, -- Need R | |
| p0AlphaSetforSRS-r17 | P0AlphaSet-r17 |
| OPTIONAL -- Need R | |
| } | |
| P0AlphaSet-r17 ::= | SEQUENCE { |
| p0-r17 | INTEGER (−16..15) |
| OPTIONAL, -- Need R | |
| alpha-r17 | Alpha |
| OPTIONAL, -- Need S | |
| closedLoopIndex-r17 | ENUMERATED { i0, i1 } |

}
Uplink-powerControlId-r17 ::= INTEGER(1.. maxUL-TCI-r17)

Uplink-PowerControl field descriptions

p0AlphaSetforPUSCH, p0AlphaSetforPUCCH, p0AlphaSetforSRS
Configures power control parameters for PUSCH, PUCCH and SRS (see TS 38.213 [13], clause 7.2). When the field
alpha is absent in p0AlphaSetforPUSCH, the UE applies the value 1 for PUSCH power control. When the field alpha is
absent in p0AlphaSetforSRS, the UE applies the value 1 for SRS power control. In p0AlphaSetForPUCCH, the field
alpha is absent (not used).

...
MIMOParam-r17 ::= SEQUENCE {
...

| | |
|---|---|
| unifiedTCI-StateType-r17 | ENUMERATED {separate, joint} |

OPTIONAL, -- Need R

| | |
|---|---|
| uplink-PowerControlToAddModList-r17 | SEQUENCE (SIZE (1..maxUL-TCI-r17)) OF Uplink-powerControl- |

r17 OPTIONAL, -- Need N

| | |
|---|---|
| uplink-PowerControlToReleaseList-r17 | SEQUENCE (SIZE (1..maxUL-TCI-r17)) OF Uplink-powerControlId- |

r17 OPTIONAL, -- Need N
...
}

### PUSCH-PowerControl

The IE PUSCH-PowerControl is used to configure UE specific power control parameter for PUSCH.

### PUSCH-PowerControl Information Element

| | |
|---|---|
| PUSCH-PowerControl ::= | SEQUENCE { |
| p0-AlphaSets | SEQUENCE (SIZE (1..maxNrofP0-PUSCH-AlphaSets)) OF P0-PUSCH- |

| | |
|---|---|
| AlphaSet | OPTIONAL, -- Need M |

| | |
|---|---|
| pathlossReferenceRSToAddModList | SEQUENCE (SIZE (1..maxNrofPUSCH-PathlossReferenceRSs)) OF |

PUSCH-PathlossReferenceRS

| | |
|---|---|
| OPTIONAL, | -- Need N |

| | |
|---|---|
| pathlossReferenceRSToReleaseList | SEQUENCE (SIZE (1..maxNrofPUSCH-PathlossReferenceRSs)) OF |

PUSCH-PathlossReferenceRS-Id

| | |
|---|---|
| OPTIONAL, | -- Need N |

| | |
|---|---|
| twoPUSCH-PC-AdjustmentStates | ENUMERATED {twoStates} |

| | |
|---|---|
| OPTIONAL, | -- Need S |

| | |
|---|---|
| sri-PUSCH-MappingToAddModList | SEQUENCE (SIZE (1..maxNrofSRI-PUSCH-Mappings)) OF SRI-PUSCH- |

PowerControl

| | |
|---|---|
| OPTIONAL, | -- Need N |

| | |
|---|---|
| sri-PUSCH-MappingToReleaseList | SEQUENCE (SIZE (1..maxNrofSRI-PUSCH-Mappings)) OF SRI-PUSCH- |

PowerControlId

| | |
|---|---|
| OPTIONAL | -- Need N |

}

| | |
|---|---|
| P0-PUSCH-AlphaSet ::= | SEQUENCE { |
| p0-PUSCH-AlphaSetId | P0-PUSCH-AlphaSetId, |
| p0 | INTEGER (−16..15) |

| | |
|---|---|
| OPTIONAL, | -- Need S |

| | |
|---|---|
| alpha | Alpha |

| | |
|---|---|
| OPTIONAL | -- Need S |

}

| | |
|---|---|
| P0-PUSCH-AlphaSetId ::= | INTEGER (0..maxNrofP0-PUSCH-AlphaSets-1) |

...
PUSCH-PathlossReferenceRS-Id-r17 ::= INTEGER (0..maxNrofPUSCH-PathlossReferenceRSs-1-r16)

| | |
|---|---|
| SRI-PUSCH-PowerControl ::= | SEQUENCE { |
| sri-PUSCH-PowerControlId | SRI-PUSCH-PowerControlId, |
| sri-PUSCH-PathlossReferenceRS-Id | PUSCH-PathlossReferenceRS-Id, |
| sri-P0-PUSCH-AlphaSetId | P0-PUSCH-AlphaSetId, |
| sri-PUSCH-ClosedLoopIndex | ENUMERATED { i0, i1 } |

}

| | |
|---|---|
| SRI-PUSCH-PowerControlId ::= | INTEGER (0..maxNrofSRI-PUSCH-Mappings-1) |

}

P0-PUSCH-AlphaSet field descriptions

alpha
alpha value for PUSCH with grant (except msg3) (see TS 38.213 [13],
clause 7.1). When the field is absent the UE applies the value 1.
p0
P0 value for PUSCH with grant (except msg3) in steps of 1 dB (see TS
38.213 [13], clause 7.1). When the field is absent the UE applies the
value 0.

PUSCH-PowerControl field descriptions
. . .
p0-AlphaSets
Configuration {p0-pusch, alpha} sets for PUSCH (except msg3 and msgA PUSCH), i.e., {{p0, alpha,index1},
{p0, alpha, index2}, . . . } (see TS 38.213 [13], clause 7.1). . . .
. . .
pathlossReferenceRSToAddModList, pathlossReferenceRSToAddModListSizeExt
A set of Reference Signals (e.g. a CSI-RS config or a SS block) to be used for PUSCH path loss estimation. The set
consists of Reference Signals configured using pathLossReferenceRSToAddModList and Reference Signals configured
using pathlossReferenceRSToAddModListSizeExt. Up to maxNrofPUSCH-PathlossReferenceRSs may be configured
(see TS 38.213 [13], clause 7.1).
pathlossReferenceRSToReleaseList, pathlossReferenceRSToReleaseListSizeExt
Lists of reference signals for PUSCH path loss estimation to be released by the UE.
sri-PUSCH-MappingToAddModList
A list of SRI-PUSCH-PowerControl elements among which one is selected by the SRI field in DCI (see TS 38.213 [13],
clause 7.1).
twoPUSCH-PC-AdjustmentStates
Number of PUSCH power control adjustment states maintained by the UE (i.e., fc(i)). If the field is present (n2) the UE
maintains two power control states (i.e., fc(i, 0) and fc(i, 1)). If the field is absent, it maintains one power control state
(i.e., fc(i, 0)) (see TS 38.213 [13], clause 7.1).
SRI-PUSCH-PowerControl field descriptions
sri-P0-PUSCH-AlphaSetId
The ID of a P0-PUSCH-AlphaSet as configured in p0-AlphaSets in PUSCH-PowerControl.
sri-PUSCH-ClosedLoopIndex
The index of the closed power control loop associated with this SRI-PUSCH-PowerControl.
sri-PUSCH-PathlossReferenceRS-Id
The ID of PUSCH-PathlossReferenceRS as configured in the pathlossReferenceRSToAddModList in PUSCH-
PowerControl.
sri-PUSCH-PowerControlId
The ID of this SRI-PUSCH-PowerControl configuration. It is used as the codepoint (payload) in the SRI DCI field.

### PathlossReferenceRS

The IE PathlossReferenceRS is used to configure a Reference Signal (e.g. a CSI-RS config or a SS block) to be used for path loss estimation for PUSCH, PUCCH and SRS for unified TCI state operation.

### PathlossReferenceRS Information Element

| PathlossReferenceRS-r17 ::= | SEQUENCE { |
|---|---|
| pathlossReferenceRS-Id-r17 | PathlossReferenceRS-Id-r17, |
| referenceSignal-r17 | CHOICE { |
| ssb-Index | SSB-Index, |
| csi-RS-Index | NZP-CSI-RS-ResourceId |
| }, | |
| additionalPCI-r17 | AdditionalPCIIndex-r17 |

OPTIONAL -- Cond RS-SSB
}

PathlossReferenceRS field descriptions

additionalPCI
Indicates the physical cell ID (PCI) of the SSB for the referenceSignal.

### PathlossReferenceRS-Id

The IE PathlossReferenceRS-Id is an ID for a reference signal (RS) configured as PUSCH, PUCCH and SRS pathloss reference RS for unified TCI state operation.

### SRS-Config

The IE SRS-Config is used to configure sounding reference signal transmissions. The configuration defines a list of SRS-Resources, a list of SRS-PosResources, a list of SRS-PosResourceSets and a list of SRS-ResourceSets. Each resource set defines a set of SRS-Resources or SRS-PosResources. The network triggers the transmission of the set of SRS-Resources or SRS-PosResources using a configured aperiodicSRS-ResourceTrigger (L1 DCI). The network does not configure SRS specific power control parameters, alpha (without suffix), p0 (without suffix) or pathlossReferenceRS if unifiedTCI-StateType is configured for the serving cell.

### SRS-Config Information Element

| | |
|---|---|
| SRS-Config ::= | SEQUENCE { |
| srs-ResourceSetToReleaseList | SEQUENCE (SIZE (1..maxNrofSRS-ResourceSets)) OF SRS- |

| | |
|---|---|
| ResourceSetId | OPTIONAL, -- Need N |

| | |
|---|---|
| srs-ResourceSetToAddModList | SEQUENCE (SIZE (1..maxNrofSRS-ResourceSets)) OF SRS- |

| | |
|---|---|
| ResourceSet | OPTIONAL, -- Need N |

| | |
|---|---|
| srs-ResourceToReleaseList | SEQUENCE (SIZE (1..maxNrofSRS-Resources)) OF SRS- |

| | |
|---|---|
| ResourceId | OPTIONAL, -- Need N |

| | |
|---|---|
| srs-ResourceToAddModList | SEQUENCE (SIZE (1..maxNrofSRS-Resources)) OF SRS-Resource |

| | |
|---|---|
| OPTIONAL, | -- Need N |

...}

| SRS-ResourceSet ::= | | SEQUENCE { |
|---|---|---|
| srs-ResourceSetId | | SRS-ResourceSetId, |
| srs-ResourceIdList | | SEQUENCE (SIZE (1..maxNrofSRS-ResourcesPerSet)) OF SRS- |
| ResourceId | OPTIONAL, -- Cond Setup | |

```
  ...
  },
```

| | |
|---|---|
| usage | ENUMERATED {beamManagement, codebook, nonCodebook, |

antennaSwitching},

| | |
|---|---|
| alpha | Alpha |

| | |
|---|---|
| OPTIONAL, | -- Need S |

| | |
|---|---|
| p0 | INTEGER (−202..24) |

| | |
|---|---|
| OPTIONAL, | -- Cond Setup |

| | |
|---|---|
| pathlossReferenceRS | PathlossReferenceRS-Config |

| | |
|---|---|
| OPTIONAL, | -- Need M |

| | |
|---|---|
| srs-PowerControlAdjustmentStates | ENUMERATED { sameAsFci2, separateClosedLoop} |

| | |
|---|---|
| OPTIONAL, | -- Need S |

```
  ...,
  [[
```

| | |
|---|---|
| pathlossReferenceRSList-r16 | SetupRelease { PathlossReferenceRSList-r16} |

| | |
|---|---|
| OPTIONAL | -- Need M |

```
  ]],
  [[
```

| | |
|---|---|
| followUnifiedTCI-StateSRS-r17 | ENUMERATED {enabled} |

| | |
|---|---|
| OPTIONAL | -- Need R |

```
  ]],
  [[
```

| | |
|---|---|
| applyIndicatedTCI-State-r18 | ENUMERATED {first, second} |

| | |
|---|---|
| OPTIONAL | -- Cond FollowUTCI |

]]
}

| | |
|---|---|
| PathlossReferenceRS-Config ::= | CHOICE { |
| ssb-Index | SSB-Index, |
| csi-RS-Index | NZP-CSI-RS-ResourceId |

}

| | |
|---|---|
| PathlossReferenceRSList-r16 ::= | SEQUENCE (SIZE (1..maxNrofSRS-PathlossReferenceRS-r16)) |

OF PathlossReferenceRS-r16

| | |
|---|---|
| PathlossReferenceRS-r16 ::= | SEQUENCE { |
| srs-PathlossReferenceRS-Id-r16 | SRS-PathlossReferenceRS-Id-r16, |
| pathlossReferenceRS-r16 | PathlossReferenceRS-Config |

}

| | |
|---|---|
| SRS-PathlossReferenceRS-Id-r16 ::= | INTEGER (0..maxNrofSRS-PathlossReferenceRS-1-r16) |

}

| | |
|---|---|
| SRS-ResourceSetId ::= | INTEGER (0..maxNrofSRS-ResourceSets-1) |
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

| | |
|---|---|
| OPTIONAL, | -- Need R |

| | |
|---|---|
| ... | |
| srs-TCI-State-r17 | CHOICE { |
| srs-UL-TCI-State | TCI-UL-StateId-r17, |
| srs-DLorJointTCI-State | TCI-StateId |

}

| | |
|---|---|
| OPTIONAL | -- Need R |

```
  ]],
  [[
  ...
```

| | |
|---|---|
| srs-DLorJointTCI-State-v1730 | SEQUENCE { |
| cellAndBWP-r17 | ServingCellAndBWP-Id-r17 |

}

| | |
|---|---|
| OPTIONAL | -- Cond DLorJointTCI-SRS |

```
  ]],
  [[
```

| | |
|---|---|
| nrofSRS-Ports-n8-r18 | ENUMERATED {ports8, ports8tdm} |

| | |
|---|---|
| OPTIONAL, | -- Need R |

```
  ...
  ]]
}
}
...
```

| | |
|---|---|
| SRS-ResourceId ::= | INTEGER (0..maxNrofSRS-Resources-1) |

}

srs-TCI-State
Configuration of either a UL TCI state or a joint TCI state for the SRS resource. In case of UL TCI-State, refers to the
TCI state defined in ul-TCI-StateList in the BWP-UplinkDedicated where the SRS-Config is configured. In case of joint
TCI state, refers to a TCI state defined in dl-OrJointTCI-StateList in pdsch-Config of the BWP-DownlinkDedicated and
serving cell indicated by cellAndBWP. This field is absent when the SRS resource is in an SRS-ResourceSet configured
with followUnifiedTCI-StateSRS-r17 or applyIndicatedTCI-State, or when the field unifiedTCI-StateType is not
configured to the serving cell which the SRS resource is located in.

SRS-ResourceSet, SRS-PosResourceSet field descriptions

alpha
alpha value for SRS power control (see TS 38.213 [13], clause 7.3). When the field is absent the UE applies the value
1. For SRS for positioning configuration in multiple cells this field is commonly configured across cells within the validity
area.
applyIndicatedTCI-State
This field indicates, for an SRS-ResourceSet, if UE applies the first or the second “indicated” UL only TCI or joint TCI as
specified in TS 38.214 [19], clause 6.2.1. If more than one value for the field coresetPoolIndex is configured in IE
controlResourceSet for the BWP, the value ‘first’ corresponds to the “indicated” joint/UL TCI states specific to
coresetPoolIndex value 0 and the value ‘second’ correspond to the value 1, respectively. When UE is configured with
two SRS resource sets with usage set to Codebook or nonCodebook, network does not configure the first set with value
‘second’ or second set with value ‘first’.
followUnifiedTCI-StateSRS
When set to enabled, for SRS resource Set, the UE applies the “indicated” UL only TCI or joint TCI as specified in TS
38.214 [19], clause 5.1.5. This parameter may be configured for aperiodic SRS for BM or SRS of any time-domain
behavior for codebook, non-codebook, and antenna switching.
p0
P0 value for SRS power control. The value is in dBm. Only even values (step size 2) are allowed (see TS 38.213 [13],
clause 7.3). For SRS for positioning configuration in multiple cells this field is commonly configured across cells within
the validity area.
pathlossReferenceRS
A reference signal (e.g. a CSI-RS config or a SS block) to be used for SRS path loss estimation (see TS 38.213 [13],
clause 7.3).
pathlossReferenceRSList
Multiple candidate pathloss reference RS(s) for SRS power control, where one candidate RS can be mapped to SRS
Resource Set via MAC CE (clause 6.1.3.27 in TS 38.321 [3]). The network can only configure this field if
pathlossReferenceRS is not configured in the same SRS-ResourceSet.
resourceType
Time domain behavior of SRS resource configuration, see TS 38.214 [19], clause 6.2.1. . . .
srs-PowerControlAdjustmentStates
Indicates whether hsrs, c(i) = fc(i, 1) or hsrs, c(i) = fc(i, 2) (if twoPUSCH-PC-AdjustmentStates are configured) or separate
close loop is configured for SRS. This parameter is applicable only for UIs on which UE also transmits PUSCH. If
absent or release, the UE applies the value sameAs-Fci1 (see TS 38.213 [13], clause 7.3).
srs-ResourceIdList, srs-PosResourceIdList
The IDs of the SRS-Resources/SRS-PosResource used in this SRS-ResourceSet/SRS-PosResourceSet. If this SRS-
ResourceSet is configured with usage set to codebook, the srs-ResourceIdList contains at most 2 entries. If this SRS-
ResourceSet is configured with usage set to nonCodebook, the srs-ResourceIdList contains at most 4 entries. . . .
srs-ResourceSetId, srs-PosResourceSetId
The ID of this resource set. It is unique in the context of the BWP in which the parent SRS-Config is defined. . . .
usage
Indicates if the SRS resource set is used for beam management, codebook based or non-codebook based transmission
or antenna switching. See TS 38.214 [19], clause 6.2.1. . . .

In [6] 3GPP TS 38.321 i00, relevant MAC CE and procedures are quoted below:

### 6.1.3.28 PUSCH Pathloss Reference RS Update MAC CE

The PUSCH Pathloss Reference RS Update MAC CE is identified by a MAC subheader with eLCID as specified in Table 6.2.1-1b. It has a variable size and consists of the following fields:
T: If the UE is configured with two SRS resources sets for codebook or non-codebook, as specified in TS 38.331 [5], in the indicated bandwidth part of the indicated Serving Cell, if this field is set to 0, SRI ID(s) to be updated are the ones associated with the first SRS resource set, and if is set to 1 the SRI ID(s) to be updated are the ones associated with the second SRS resource set. Otherwise, this field is a reserved bit set to 0;
PUSCH Pathloss Reference RS ID: This field indicates the PUSCH Pathloss Reference RS ID identified by PUSCH-PathlossReferenceRS-Id as specified in TS 38.331 [5], which is to be updated in the SRI PUSCH power control mappings indicated by SRI ID fields indicated in the same MAC CE. The length of the field is 6 bits;
C: This field indicates the presence of the additional SRI ID in the last octet of this MAC CE. If this field is set to 1, two SRI ID(s) are present in the last octet. Otherwise only one SRI ID (i.e. the first SRI ID) is present in the last octet;
SRI ID: This field indicates the SRI PUSCH power control ID identified by sri-PUSCH-PowerControlld as specified in TS 38.331 [5]. The length of the field is 4 bits;

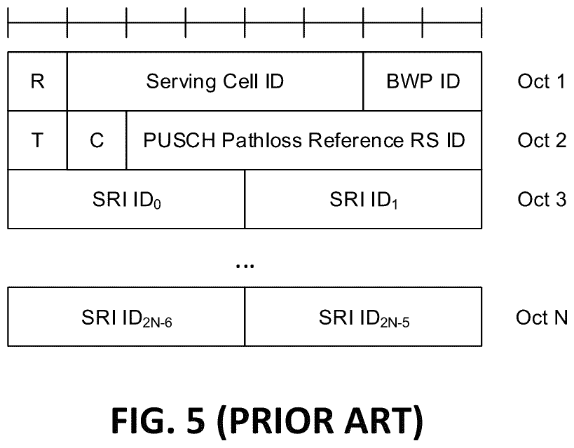

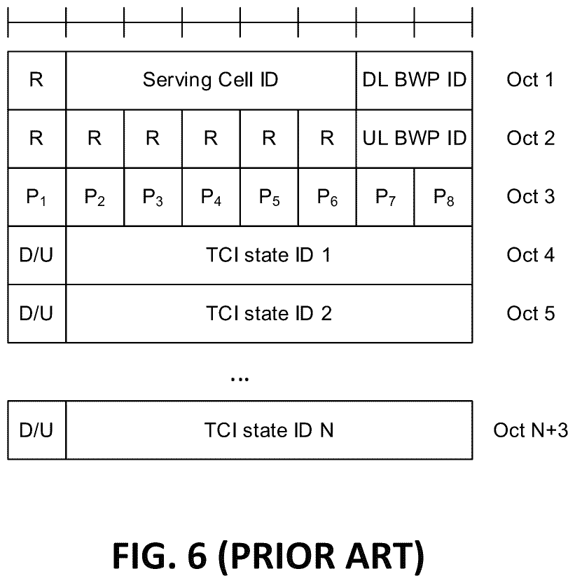

FIG. 5 is a reproduction of FIG. 6.1.3.28-1: PUSCH Pathloss Reference RS Update MAC CE, from 3GPP TS 38.321 100.

### 6.1.3.47 Unified TCI States Activation/Deactivation MAC CE

The Unified TCI States Activation/Deactivation MAC CE is identified by a MAC subheader with eLCID as specified in Table 6.2.1-1b. It has a variable size consisting of following fields:
Pᵢ: This field indicates whether each TCI codepoint has multiple TCI states or single TCI state. If Pᵢ field is set to 1, it indicates that i^{th} TCI codepoint includes the DL TCI state and the UL TCI state. If Pᵢ field is set to 0, it indicates that i^{th} TCI codepoint includes only the DL/joint TCI state or the UL TCI state. The codepoint to which a TCI state is mapped is determined by its ordinal position among all the TCI state ID fields;
D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId as specified in TS 38.331 [5]. If D/U is set to 1, 7-bits length TCI state ID i.e. TCI-StateId as specified in TS 38.331 [5] is used. If D/U is set to 0, the most significant bit of TCI state ID is considered as the reserved bit and remainder 6 bits indicate the TCI-UL-State-Id as specified in TS 38.331 [5]. The maximum number of activated TCI states is 16;

FIG. 6 is a reproduction of FIG. 6.1.3.47-1: Unified TCI state activation/deactivation MAC CE, from 3GPP TS 38.321 100.

6.1.3.60 Serving Cell Set based SRS TCI State Indication MAC CE

The Serving Cell Set based SRS TCI State Indication MAC CE is identified by a MAC subheader with eLCID as specified. It has a variable size with following fields:
C: This field indicates whether the octets containing TCI State Serving Cell ID field(s) and TCI State BWP ID field(s) are present. If this field is set to 1, the TCI State Serving Cell ID field(s) and TCI State BWP ID field(s) are present, otherwise they are not present so MAC entity shall ignore TCI State Serving Cell ID field(s) and TCI State BWP ID field(s);
SRS Resource IDᵢ: This field indicates the SP/AP SRS Resource ID identified by SRS-ResourceId as specified in TS 38.331 [5]. The length of the field is 6 bits;
TCI State Serving Cell IDᵢ: This field indicates the identity of the Serving Cell on which the TCI State used for SRS Resource IDᵢ is located. The length of the field is 5 bits;
TCI State IDᵢ: This field contains an identifier of the TCI state used for SRS resource i. TCI State ID₀ refers to the first SRS resource which is indicated SRS Resource ID₀, TCI State IDI refers to the second one and so on. If joint/downlink TCI State is used, 7-bits length TCI state ID i.e. TCI-StateId as specified in TS 38.331 [5] is used. If separate downlink and uplink TCI State is used, the most significant bit of TCI state ID is considered as a reserved bit and the remaining 6 bits indicate the TCI-UL-State-Id as specified in TS 38.331 [5]. The length of the field is 7 bits;

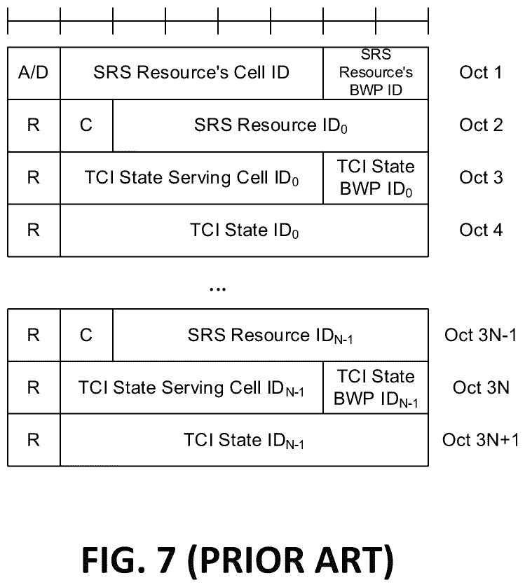

FIG. 7 is a reproduction of FIG. 6.1.3.60-1: Serving Cell Set based SRS TCI State Indication MAC CE, from 3GPP TS 38.321 100.

### 6.1.3.70 Enhanced Unified TCI States Activation/Deactivation MAC CE for Joint TCI States

The Enhanced Unified TCI States Activation/Deactivation MAC CE for Joint TCI States is identified by a MAC subheader with eLCID as specified in Table 6.2.1-1b. It has a variable size consisting of following fields:
F_{i,j}: This field indicates for the TCI state ID fields associated with the codepoint i of the DCI Transmission Configuration Indication field whether the j-th joint TCI state is present or not, where j=1, 2. If F_{i,j} field is set to 1, it indicates the j-th joint TCI state for codepoint i is present. If F_{i,j} field is set to 0, it indicates the j-th joint TCI state for codepoint i is absent. The codepoint to which a TCI state is mapped is determined by its ordinal position among all the TCI state ID fields;
TCI state ID: This field indicates the 7-bits length TCI state ID identified by TCI-StateId as specified in TS 38.331 [5]. The maximum number of activated TCI states is 16;

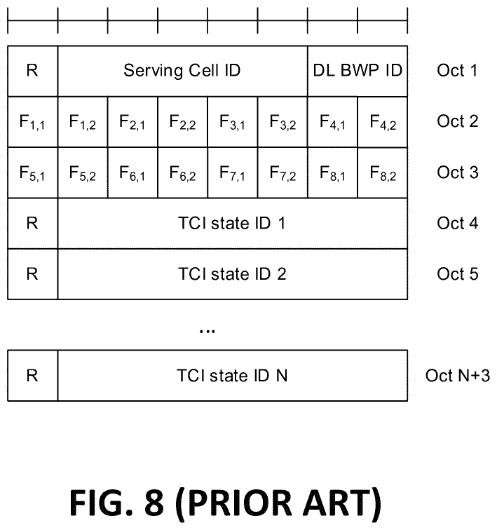

FIG. 8 is a reproduction of FIG. 6.1.3.70-1: Enhanced TCI state activation/deactivation MAC CE for Joint TCI States, from 3GPP TS 38.321 i00.

### 6.1.3.71 Enhanced Unified TCI States Activation/Deactivation MAC CE for Separate TCI States

The Enhanced Unified TCI States Activation/Deactivation MAC CE for Separate TCI States is identified by a MAC subheader with eLCID as specified in Table 6.2.1-1b. It has a variable size consisting of following fields:
F_{i,j}: This field indicates for the TCI state ID fields associated with the codepoint i of the DCI Transmission Configuration Indication field whether the j-th DL TCI state is present or not, where j=1, 2. If F_{i,j} field is set to 1, it indicates the j-th DL TCI state for codepoint i is present. If F_{i,j} field is set to 0, it indicates the j-th DL TCI state for codepoint i is absent;
S_{i,j}: This field indicates for the TCI state ID fields associated with the codepoint i of the DCI Transmission Configuration Indication field whether the j-th UL TCI state is present or not, where j=1, 2. If S_{i,j} field is set to 1, it indicates the j-th UL TCI state for codepoint i is present. If S_{i,j} field is set to 0, it indicates the j-th UL TCI state for codepoint i is absent;
TCI state ID: This field indicates the TCI state identified by TCI-StateId as specified in TS 38.331 [5]. If the indicated TCI state ID is DL TCI state, 7-bits length TCI state ID, i.e. TCI-StateId, as specified in TS 38.331 [5] is used. If the indicated TCI state ID is UL TCI state, the most significant bit of TCI state ID is considered as the reserved bit and remainder 6 bits indicate the TCI-UL-State-Id as specified in TS 38.331 [5]. TCI state IDs are in the order of indication of F_{i,j} and S_{i,j} fields. The maximum number of activated TCI states is 32;

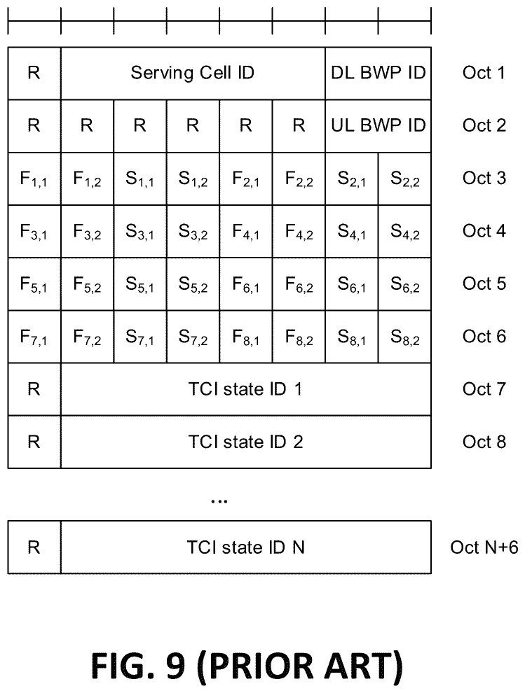

FIG. 9 is a reproduction of FIG. 6.1.3.71-1: Enhanced TCI state activation/deactivation MAC CE for Separate TCI States, from 3GPP TS 38.321 i00.

### 5.4.6 Power Headroom Reporting

The Power Headroom reporting procedure is used to provide the serving gNB with the following information:
Type 1 power headroom: the difference between the nominal UE maximum transmit power and the estimated power for UL-SCH transmission per activated Serving Cell;
Type 3 power headroom: the difference between the nominal UE maximum transmit power and the estimated power for SRS transmission per activated Serving Cell;

If the MAC entity has UL resources allocated for a new transmission the MAC entity shall:
1> if the Power Headroom reporting procedure determines that at least one PHR has been triggered and not cancelled; and
1> if the allocated UL resources can accommodate the MAC CE for PHR which the MAC entity is configured to transmit, plus its subheader, as a result of LCP as defined in clause 5.4.3.1:
   2> if multiplePHR with value true is configured:
      3> for each activated Serving Cell with configured uplink associated with any MAC entity of which the active DL BWP is not dormant BWP; and
      3> for each activated Serving Cell with configured uplink associated with E-UTRA MAC entity:
         4> if this MAC entity is configured with twoPHRMode:
         5> if this Serving Cell is configured with multiple TRP PUSCH repetition and the MAC entity this Serving Cell belongs to is configured with twoPHRMode:
         6>obtain two values of the Type 1 or the value of Type 3 power headroom for the corresponding uplink carrier as specified in clause 7.7 of TS 38.213 [6] for NR Serving Cell.
         5> else:
         6>obtain the value of the Type 1 or Type 3 power headroom for the corresponding uplink carrier as specified in clause 7.7 of TS 38.213 [6] for NR Serving Cell and clause 5.1.1.2 of TS 36.213 for E-UTRA Serving Cell.
         4> else (i.e. this MAC entity is not configured with twoPHRMode):
         5> if this Serving Cell is configured with multiple TRP PUSCH repetition and the MAC entity this Serving Cell belongs to is configured with twoPHRMode:
         6> if there is at least one real PUSCH transmission at the slot where the PHR MAC CE is transmitted:
         7>obtain the value of the Type 1 power headroom of the first real transmission of the corresponding uplink carrier as specified in clause 7.7 of TS 38.213 [6] for NR Serving Cell.
         6> else if there is no real PUSCH transmission at the slot where the PHR MAC CE is transmitted:
         7>obtain the value of the type 1 power headroom of the reference PUSCH transmission associated with the SRS-ResourceSet with a lower SRS-resourceSetID or the value of the type 3 power headroom for the corresponding uplink carrier as specified in clause 7.7 of TS 38.213 [6] for NR Serving Cell.
         5> else:
         6>obtain the value of the Type 1 or Type 3 power headroom for the corresponding uplink carrier as specified in clause 7.7 of TS 38.213 [6] for NR Serving Cell and clause 5.1.1.2 of TS 36.213 for E-UTRA Serving Cell.
         4> if this MAC entity has UL resources allocated for transmission on this Serving Cell; or
      3>instruct the Multiplexing and Assembly procedure to generate and transmit the Enhanced Multiple entry PHR as defined in clause 6.1.3.49 if this MAC entity is configured with mpe-Reporting-FR2-r17 or the Enhanced Multiple Entry PHR for multiple TRP MAC CE as defined in clause 6.1.3.51 if this MAC entity is configured with twoPHRMode or the Multiple Entry PHR MAC CE as defined in clause 6.1.3.9 otherwise based on the values reported by the physical layer.
   2> else (i.e. Single Entry PHR format is used):
      3> if this MAC entity is configured with twoPHRMode:
         4>obtain two values of the Type 1 power headroom from the physical layer for the corresponding uplink carrier of the PCell.
      3> else:
         4>obtain the value of the Type 1 power headroom from the physical layer for the corresponding uplink carrier of the PCell.
      3>obtain the value for the corresponding PCMAX,f,c field from the physical layer;
      3>instruct the Multiplexing and Assembly procedure to generate and transmit the Enhanced Single entry PHR as defined in clause 6.1.3.48 if this MAC entity is configured with mpe-Reporting-FR2-r17 or the Enhanced Single Entry PHR for multiple TRP MAC CE as defined in clause 6.1.3.50 if this MAC entity is configured with twoPHRMode or the Single Entry PHR MAC CE as defined in clause 6.1.3.8 otherwise based on the values reported by the physical layer.

In [7] 3GPP TS 38.213 i00, the following is provided:

### 7 Uplink Power Control

In the remaining of this clause, if a UE is provided TCI-State in dl-OrJointTCI-StateList or TCI-UL-State, and for each indicated one or two TCI-State or TCI-UL-State of a PUSCH, PUCCH, or SRS transmission occasion as described in [6, TS 38.214]
in clauses 7.1.1, 7.2.1, and 7.3.1, the RS index qa for obtaining the downlink pathloss estimate for PUSCH, PUCCH, and SRS transmission is provided by pathlossReferenceRS-Id-r17 associated with or included in the indicated TCI-State or TCI-UL-State except for SRS transmission that is not provided followUnifiedTCI-StateSRS
in clause 7.1.1, if p0AlphaSetforPUSCH is provided, the values of P_{O_UE_PUSCH,b,f,c}(j), a_{b,f,c}(j), and the PUSCH power control adjustment state l are provided by p0AlphaSetforPUSCH associated with the indicated TCI-State or TCI-UL-State
in clause 7.2.1, if p0AlphaSetforPUCCH is provided, the values of P_{O_UE_PUCCH}(qᵤ) and the PUCCH power control adjustment state l are provided by p0AlphaSetforPUCCH associated with the indicated TCI-State or TCI-UL-State
in clause 7.3.1, if pOAlphaSetforSRS is provided,
   if followUnifiedTCI-StateSRS is provided for a SRS resource set, the values of P_{O_UE_SRS,b,f,c}(qₛ), a_{SRS,b,f,c}(qₛ), and SRS power control adjustment state l are provided by p0AlphaSetforSRS associated with the indicated TCI-State or TCI-UL-State
   else, if followUnifiedTCI-StateSRS is not provided for a SRS resource set and for a SRS resource from the SRS resource set, the values of P_{O_UE_SRS,b,f,c}(qₛ), a_{SRS,b,f,c}(qₛ), and SRS power control adjustment state l are provided by p0AlphaSetforSRS associated with TCI-State or TCI-UL-State of an SRS resource with lowest SRS-ResourceId in the SRS resource set and a RS index q_{d} for obtaining a pathloss estimate for the SRS transmission is provided by pathlossReferenceRS-Id-r17 associated with or included in the TCI-State or TCI-UL-State of an SRS resource with lowest SRS-ResourceId in the SRS resource set
P_{O_SRS,b,f,c}(qₛ) is the sum of the component P_{O_UE_SRS,b,f,c}(qₛ) and a component p0 provided by SRS-ResourceSet corresponding to the SRS resource set.

### 7.1.1 UE Behaviour

If a UE transmits a PUSCH on active UL BWP b of carrier f of serving cell c using parameter set configuration with index j and PUSCH power control adjustment state with index l, the UE determines the PUSCH transmission power P_{PUSCH,b,f,c}(i, j, q_{d}, l) in PUSCH transmission occasion i as

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot \\ {PL}_{b , f , c} ( {q}_{d} ) + {Δ}_{TF , b , f , c} ( i ) + {f}_{b , f , c} ( i , l )\end{matrix}\end{matrix} \} [ dBm ]$$

where,
P_{CMAX,f,c}(i) is the UE configured maximum output power defined in [8-1, TS 38.101-1], [8-2, TS 38.101-2] and [8-3, TS 38.101-3] for carrier f of serving cell c in PUSCH transmission occasion i.
P_{O_PUSCH,b,f,c}(j) is a parameter composed of the sum of a component P_{O_NOMINAL, PUSCH,f,c}(j) and a component P_{O_UE_PUSCH,b,f,c}(j) where jϵ{0,1, . . . , J−1}.
   else, the UE determines a value of P_{O_UE_PUSCH,b,f,c}(j) from the value of the second P0-PUSCH-AlphaSet in p0-AlphaSets
PL_{b,f,c}(q_{d}) is a downlink pathloss estimate in dB calculated by the UE using reference signal (RS) index q_{d} for the active DL BWP, as described in clause 12, of carrier f of serving cell c
PL_{b,f,c}(q_{d})=referenceSignalPower-higher layer filtered RSRP, where referenceSignalPower is provided by higher layers and RSRP is defined in [7, TS 38.215] for the reference serving cell and the higher layer filter configuration provided by QuantityConfig is defined in [12, TS 38.331] for the reference serving cell
For the PUSCH power control adjustment state f_{b,f,c}(i, l) for active UL BWP b of carrier f of serving cell c in PUSCH transmission occasion i
   δ_{PUSCH,b,f,c}(i, l) is a TPC command value included in a DCI format that schedules the PUSCH transmission occasion i on active UL BWP b of carrier f of serving cell c or jointly coded with other TPC commands in a DCI format 2_2 with CRC scrambled by TPC-PUSCH-RNTI, as described in clause 11.3
      lϵ{0,1} if the UE is configured with twoPUSCH-PC-AdjustmentStates and l=0 if the UE is not configured with twoPUSCH-PC-AdjustmentStates or if the PUSCH transmission is scheduled by a RAR UL grant as described in clause 8.3

### 7.3.1 UE Behaviour

If a UE transmits SRS based on a configuration by SRS-ResourceSet on active UL BWP b of carrier f of serving cell c using SRS power control adjustment state with index l, the UE determines the SRS transmission power P_{SRS,b,f,c}(i, qₛ, l) in SRS transmission occasion i as

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{d} ) \cdot \\ {PL}_{b , f , c} ( {q}_{d} ) + {h}_{b , f , c} ( i , l )\end{matrix}\end{matrix} \} [ dBm ]$$

where,
P_{CMAX,f,c}(i) is the UE configured maximum output power defined in [8, TS 38.101-1], [8-2, TS 38.101-2] and [TS 38.101-3] for carrier f of serving cell c in SRS transmission occasion i
P_{O_SRS,b,f,c}(qₛ) is provided by p0 for active UL BWP b of carrier f of serving cell c and SRS resource set qₛ provided by SRS-ResourceSet and SRS-ResourceSetId
M_{SRS,b,f,c}(i) is a SRS bandwidth expressed in number of resource blocks for SRS transmission occasion i on active UL BWP b of carrier f of serving cell c and μ is a SCS configuration defined in [4, TS 38.211]
a_{SRS,b,f,c}(qₛ) is provided by alpha for active UL BWP b of carrier f of serving cell c and SRS resource set qs
PL_{b,f,c}(q_{d}) is a downlink pathloss estimate in dB calculated by the UE using RS resource index qa as described in clause 7.1.1 for the active DL BWP of serving cell c and SRS resource set qs [6, TS 38.214]. The RS resource index q_{d} is provided by pathlossReferenceRS associated with the SRS resource set qₛ and is either an ssb-Index providing a SS/PBCH block index or a csi-RS-Index providing a CSI-RS resource index.

### 7.7 Power Headroom Report

The types of UE power headroom reports are the following. A Type 1 UE power headroom PH that is valid for PUSCH transmission occasion i on active UL BWP b of carrier f of serving cell C. A Type 3 UE power headroom PH that is valid for SRS transmission occasion i on active UL BWP b of carrier f of serving cell C.

A UE determines whether a power headroom report for an activated serving cell [11, TS 38.321] is based on an actual transmission or a reference format based on the higher layer signalling of configured grant and periodic/semi-persistent sounding reference signal transmissions and downlink control information the UE received until and including the PDCCH monitoring occasion where the UE detects the first DCI format scheduling an initial transmission of a transport block since a power headroom report was triggered if the power headroom report is reported on a PUSCH triggered by the first DCI format. Otherwise, a UE determines whether a power headroom report is based on an actual transmission or a reference format based on the higher layer signalling of configured grant and periodic/semi-persistent sounding reference signal transmissions and downlink control information the UE received until the first uplink symbol of a configured PUSCH transmission minus T′_{proc,2}=T_{proc,2} where T_{proc,2} is determined according to [6, TS 38.214] assuming d_{2,1}=1, d_{2,2}=0, and with μ_{DL} corresponding to the subcarrier spacing of the active downlink BWP of the scheduling cell for a configured grant if the power headroom report is reported on the PUSCH using the configured grant.

### 7.7.1 Type 1 PH Report

If a UE determines that a Type 1 power headroom report for an activated serving cell is based on an actual PUSCH transmission then, for PUSCH transmission occasion i on active UL BWP b of carrier f of serving cell c, the UE computes the Type 1 power headroom report as

$${PH}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

where P_{CMAX, f,c}(i), P_{O_PUSCH,b,c}(j), M_{RB,b,c}^{PUSCH}(i), a_{b,f,c}(j), PL_{b,f,c}(q_{d}), Δ_{TF,b,c}(i) and f_{b,f,c}(i, l) are defined in clause 7.1.1.

If a UE is configured with multiple cells for PUSCH transmissions, where a SCS configuration μ₁ on active UL BWP b₁ of carrier f₁ of serving cell c₁ is smaller than a SCS configuration μ₂ on active UL BWP b₂ of carrier f₂ of serving cell c₂, and if the UE provides a Type 1 power headroom report in a PUSCH transmission in a slot on active UL BWP b₁ that overlaps with multiple slots on active UL BWP b₂, the UE provides a Type 1 power headroom report for the first PUSCH, if any, on the first slot of the multiple slots on active UL BWP b₂ that fully overlaps with the slot on active UL BWP b₁. If a UE is configured with multiple cells for PUSCH transmissions, where a same SCS configuration on active UL BWP b₁ of carrier f₁ of serving cell c₁ and active UL BWP b₂ of carrier f₂ of serving cell c₂, and if the UE provides a Type 1 power headroom report in a PUSCH transmission in a slot on active UL BWP b₁, the UE provides a Type 1 power headroom report for the first PUSCH, if any, on the slot on active UL BWP b₂ that overlaps with the slot on active UL BWP b₁.

If the UE determines that a Type 1 power headroom report for an activated serving cell is based on a reference PUSCH transmission then, for PUSCH transmission occasion i on active UL BWP b of carrier f of serving cell c, the UE computes the Type 1 power headroom report as

$${PH}_{type 1 , b , f , c} ( i , j , {q}_{d} , l ) = {\tilde{P}}_{CMAX , f , c} ( i ) - \{ {P}_{O \_ PUSCH , b , f , c} ( j ) + {α}_{b , f , c} ( j ) \cdot {PL}_{b , f , c} ( {q}_{d} ) + {f}_{b , f , c} ( i , l ) \} [ dB ]$$

where P̅_{CMAX,f,c}(i) is computed assuming MPR=0 dB, A-MPR=0 dB, P-MPR=0 dB. ΔT_{C}=0 dB. MPR, A-MPR, P-MPR and ΔT_{C} are defined in [8-1, TS 38.101-1], [8-2, TS 38.101-2] and [8-3, TS 38.101-3]. The remaining parameters are defined in clause 7.1.1 and, if ul-powerControl is not provided, P_{O_PUSCH,b,f,c}(j) and a_{b,f,c}(j) are obtained using P_{O_NOMINAL,PUSCH,f,c}(0) and p0-PUSCH-AlphaSetId=0, PL_{b,f,c}(q_{d}) is obtained using pusch-PathlossReferenceRS-Id=0, and l=0. If ul-powerControl is provided, P_{O_PUSCH,b,f,c}(j), a_{b,f,c}(j) and l are obtained by p0AlphaSetforPUSCH associated with the indicated TCI-State or TCI-UL-State, PL_{b,f,c}(q_{d}) is obtained by PL-RS associated with the indicated TCI-State or TCI-UL-State.

If a UE is not provided twoPHRMode, and is provided two SRS resource sets in srs-ResourceSetToAddModList or srs-ResourceSetToAddModListDCI-0-2 with usage set to ‘codebook’ or ‘nonCodebook’ on active UL BWP b of carrier f of serving cell c, the UE provides one Type 1 power headroom report in a slot n. If the Type 1 power headroom report is for an actual PUSCH repetition, the Type 1 power headroom report is for the first PUSCH repetition associated with the first SRS resource set or the second SRS resource set that overlaps with slot n.

If a UE is provided twoPHRMode, and is provided two SRS resource sets in srs-ResourceSetToAddModList or srs-ResourceSetToAddModListDCI-0-2 with usage set to ‘codebook’ or ‘nonCodebook’ on active UL BWP b of carrier f of serving cell c, the UE provides two Type 1 power headroom reports in a slot n, where
if the UE provides a first Type 1 power headroom report for an actual PUSCH repetition of a PUSCH transmission starting earliest in slot n that is associated with one SRS resource set,
else, if the UE provides a Type 1 power headroom report for a reference PUSCH transmission associated with the first SRS resource set, the UE provides a Type 1 power headroom report for a reference PUSCH transmission associated with the second SRS resource set, where
   if a UE is provided dl-OrJointTCI-StateList or TCI-UL-State and is indicated a first TCI-State or TCI-UL-State and a second TCI-State or TCI-UL-State, the UE provides the first or the second Type 1 power headroom reports using the p0AlphaSetforPUSCH and pathlossReferenceRS-Id-r17 values associated with the first TCI-State or TCI-UL-State or with the second TCI-State or TCI-UL-State, respectively, if the reference PUSCH transmission is associated with the first TCI-State or TCI-UL-State or with the second TCI-State or TCI-UL-State, respectively

In [8] RAN1 112bis meeting report, a related agreement is quoted below:

Agreement (RAN1 #112bis)

On unified TCI framework extension for S-DCI based MTRP operation, support the followings:
For a serving cell configured with joint DL/UL TCI mode, a full-set or any sub-set of {first joint TCI state, second joint TCI state} can be mapped to a TCI codepoint of the existing TCI field in a DCI format 1_1/1_2 by TCI state activation command (MAC-CE)
For a serving cell configured with separate DL/UL TCI mode, a full-set or any sub-set of {first DL TCI state, first UL TCI state, second DL TCI state, second UL TCI state} can be mapped to a TCI codepoint of the existing TCI field in a DCI format 1_1/1_2 by TCI state activation command (MAC-CE)
TCI state activation command (MAC-CE) should indicate that each joint/DL/UL TCI state mapped to a TCI codepoint is the first or second joint/DL/UL TCI state (detail on how to indicate above is up to RAN2 design)
The first/second indicated joint/DL/UL TCI state(s) is updated according to the corresponding first/second joint/DL/UL TCI state(s) mapped to the TCI codepoint received by the UE
   If the UE receives a TCI codepoint mapped with a sub-set of {first joint TCI state, second joint TCI state} or {first DL TCI state, first UL TCI state, second DL TCI state, second UL TCI state}, the UE shall update the first/second indicated joint/DL/UL TCI state(s) according to the first/second joint/DL/UL TCI state(s) in the subset and keep other indicated first/second joint/DL/UL TCI state(s) that is not updated by the received TCI codepoint

In New Radio (NR) Rel-18, a unified Transmission Configuration Indicator (TCI) framework may require TCI state (de)activation Medium Access Control (MAC) Control Element (CE) to activate up to 32 TCI states for up to 8 code-points. One code-point could associate with up to 4 TCI states comprising 1-st Downlink (DL)/joint TCI state, 1-st Uplink (UL) TCI state, 2-nd DL/joint TCI state, and/or 2-nd UL TCI state. Preferably in certain embodiments, the 1-st DL/joint TCI state and/or 1-st UL TCI state corresponds to a 1-st Transmission-Reception Point (TRP). Preferably in certain embodiments, the 2-nd DL/joint TCI state and/or 2-nd UL TCI state corresponds to a 2-nd TRP. Based on a (beam indication) Downlink Control Information (DCI) with a TCI bit field indicating one code-point, TCI state(s) associated with the indicated code-point would be considered or determined or called an “indicated TCI state”. A User Equipment (UE) and a network node would have the same understanding on when to apply the latest indicated TCI state(s). Each code-point (in TCI state deactivation MAC CE) could be all or a subset of a {1-st DL/joint TCI state, 1-st UL TCI state, 2-nd DL/joint TCI state, and/or 2-nd UL TCI state}. Different code-points may correspond to different sets or subsets of the {1-st DL/joint TCI state, 1-st UL TCI state, 2-nd DL/joint TCI state, and/or 2-nd UL TCI state}. The {1-st DL/joint TCI state, 1-st UL TCI state, 2-nd DL/joint TCI state, and/or 2-nd UL TCI state} for code-point x may correspond to the same or different TCI state Identities (ID(s)) than for code-point y. In one example, 4 TCI states with a {DL/joint, U, D/joint, U} for code-point x and 2 TCI states with {D/joint, D/joint} for code-point y. The UE may currently apply 4 TCI states according to code-point x, and later receive a (beam indication) DCI indicating code-point y. The UE updates the 2 DL/joint TCI states according to code-point y and keeps/remains/reserves 2 UL TCI states according to code-point x. Preferably in certain embodiments, one rationale is to keep multiple TRP operations. In short, the UE may update according to a new code-point by replacing an indicated TCI state(s) while keeping a TCI state(s) which is not indicated by a new code-point. For another example, the UE has activated a code-point z comprising 1 TCI state with {D}, and {D} is associated with a 2-nd TRP. Once the UE applies the indicated code-point z, the UE updates {D} for a 2-nd TRP while keeping the TCI state associated with {D, U} for the 1-st TRP and keeping the TCI state associated with {U} for the 2-nd TRP.

In NR Rel-18, power control for unified TCI framework could be that a Pathloss Reference Signal (PL RS) is configured per TCI state (e.g., (UL/joint) a TCI state comprises a PL RS ID for indicating an associated PL RS). For UL transmission associated with one UL/joint TCI state, the UE would determine a Transmit (TX) power for the UL transmission or pathloss estimate based on a PL RS associated with the one UL/joint TCI state. Preferably in certain embodiments, an open loop power control parameter (e.g., target power P0 and alpha value) could be configured per TCI state or per UL Bandwidth Part (BWP). Preferably in certain embodiments, a UL transmission would be transmitted with spatial relation based on an indicated (and applied) one or more (UL/joint) TCI states. Preferably in certain embodiments, the UL transmission comprises Physical Uplink Shared Channel (PUSCH), Physical Uplink Control Channel (PUCCH), and Sounding Reference Signal (SRS) which is configured to follow a unified TCI.

In Rel-19, in order to improve coverage of a serving cell, a UL-only TRP or TRP with reduced DL functionality are introduced to deploy in addition to a DL/UL TRP. Due to less DL functionality from a UL-only TRP or a TRP with reduced DL functionality, power control for uplink transmission is to a UL-only TRP. However, there may be some issues for this deployment.

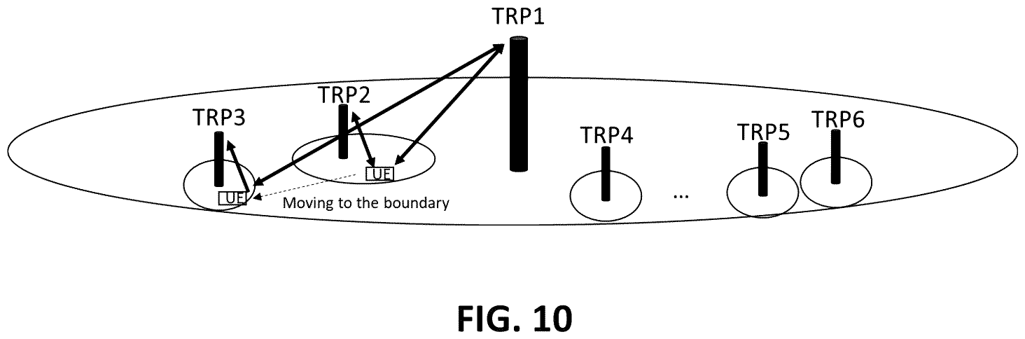

A first issue could be illustrated in FIG. 10, wherein that UE is served by TRP1 and TRP2 in the serving cell, and both TRP1 and TRP2 correspond to a DL/UL TRP. Once the UE moves to coverage of TRP3, which is an UL-only TRP or TRP with reduced DL functionality, how to activate or indicate the TCI state to the UE may need further design. For example, according to NR Rel-18 implementation, when the UE communicates with TRP1 and TRP2, the UE may apply an indicated TCI state from code-point with a {1-st DL/joint TCI state, 1-st UL TCI state, 2-nd DL/joint TCI state, and/or 2-nd UL TCI state}. However, when the UE moves to TRP3 and the network node changes indicated a TCI state to {2-nd UL TCI state}, the UE may maintain or keep the {1-st DL/joint TCI state, 1-st UL TCI state, 2-nd DL/joint TCI state} while TRP3 does not support or have DL functionality, which means a 2-nd DL/joint TCI state is no longer available. Besides, for downlink operation, multiple TRP (mTRP) operation seems to fallback to a single TRP (sTRP) operation. Although downlink dynamic scheduling may have a TCI selection field to select a single DL/joint TCI state for sTRP operation, a Channel State Information Reference Signal (CSI-RS) reception or DL channel or signal (pre-) configured to apply a 2-nd DL/joint TCI for DL reception may have the wrong TCI state for reception. For uplink dynamic scheduling, an SRS resource set indicator could indicate that PUSCH transmission is associated with a 1-st indicated UL TCI state or a 2-nd indicated UL TCI state or both indicated UL TCI states. Preferably and/or alternatively in certain embodiments, when the UE moves to TRP3, maintains activated one or more DL TCI state(s) associated with a 2-nd DL/joint TCI state in MAC CE may cause a problem due to tracking the one or more DL TCI state(s) is with less benefit to acquire TRP3's UL performance. Preferably and/or alternatively in certain embodiments, when the UE moves from TRP3 to TRP2, how to change from a UL-only TRP mode (or TRP reduced DL functionality) to a mTRP DL/UL mode is needed.

A second issue is related to power control for a UL-only TRP or a TRP with reduced DL functionality. Since there may be no DL from TRP3 in FIG. 10 for the UE to determine a pathloss estimate, it is natural to use PL RS from TRP1 (or other TRP with DL functionality) in FIG. 10 and apply a PL offset to determine a pathloss estimate. However, the characteristic of the PL offset is not so clear as to whether the PL offset is per TCI state or per TRP or per PL RS. Without proper design, once the indicated TCI state changes, the UE may fail to track the pathloss estimate by using a wrong PL offset. Since TRP3 in FIG. 10 (e.g., UL-only TRP or TRP with reduced DL functionality) may not need too much transmit power due to smaller coverage range of TRP3, the PL offset is applied to reduce transmit power derivation for the UL transmission to TRP3. The second issue is related to how the UE determines whether to apply the PL offset. When the UE moves to TRP2 in FIG. 10 or (in general) when the UE moves to a TRP in FIG. 10 (which could be either a UL-only TRP/TRP with reduced DL functionality or a DL/UL TRP), how the UE determines whether to apply the PL offset and/or how the network node signals the UE whether to apply the PL offset or not may need further design.

A first concept is to deactivate partial of (currently) activated TCI states for one serving cell when receiving a TCI state (de)activation signal (e.g., not deactivate all (currently) activated TCI states for one serving cell). Preferably in certain embodiments, when a UE has activated a first set of TCI states and a second set of TCI states based on a first TCI state (de)activation signal and a UE receives a second TCI state (de)activation signal, the UE does not deactivate the first set of TCI states (and/or keeps/remains/maintains the first set of TCI states being activated) and/or only deactivates the second set of TCI states. For example, in FIG. 10, the UE is communicating with at least TRP1, for both cases of the UE moving from TRP2 to TRP3 and moving from TRP3 to TRP2, when the UE receives a second TCI state (de)activation signal, the UE keeps the first set of TCI states associated with TRP1 activated. Preferably in certain embodiments, the first set of TCI states are associated with a first TRP. Preferably in certain embodiments, the second set of TCI states are associated with a second TRP. Preferably in certain embodiments, the first set of TCI states comprise up to 16 TCI states (including DL and/or UL). Preferably in certain embodiments, the second set of TCI states comprise up to 16 TCI states (including DL and/or UL). Preferably in certain embodiments, the second TCI state (de)activation signal indicates a third set of TCI states. Preferably in certain embodiments, the second TCI state (de)activation signal indicates a fourth set of TCI states. Preferably in certain embodiments, the third set of TCI states may associate with the first TRP. Preferably in certain embodiments, the third set of TCI states may associate with a TRP different than the first TRP. Preferably in certain embodiments, the fourth set of TCI states may associate with a TRP different than the second TRP. Preferably in certain embodiments, the third set of TCI states comprise at least one DL/joint TCI state. Preferably in certain embodiments, the fourth set of TCI states comprise without DL/joint TCI states.

Preferably in certain embodiments, the UE may, based on at least one or any combination of the following bullets, determine whether to apply the first concept:
Explicit signaling as a header of the second TCI state (de)activation signal (e.g., MAC CE header) indicating to keep activated the first set of TCI states; and/or
Explicit signaling as format of the second TCI state (de)activation signal (e.g., using one reserved bit to indicate whether to keep the first set of TCI states being activated), and/or as format of a third TCI state (de)activation signal could indicate that both set of TCI states (according to the first TCI state (de)activation signal) are deactivated; and/or
Explicit signaling as one or more bit fields in DCI scheduling PDSCH comprises/carries the second TCI state (de)activation signal (e.g., MAC CE), and the one or more bit fields indicate to keep the first set of TCI states, and/or the one or more bit fields could indicate to keep the first set of TCI states being activated, or not to keep the first set of TCI states being activated; and/or
Implicit signaling as the UE checks or determines whether the first set of TCI states indicated in the first TCI state (de)activation signal being the same as a third set of TCI states indicated by the second TCI state (de)activation signal, and/or if both the first TCI state (de)activation signal and the second TCI state (de)activation signal indicates a same set of TCI states associated with the first TRP (and a different set of TCI states associated with another TRP), the UE keeps/maintains/remains the first set of TCI states being activated, and/or if at least one TCI state in the first set of TCI states is not indicated as the third set of TCI states in the second TCI state (de)activation signal, the UE would deactivate TCI states in the first set of TCI states; and/or
Whether the fourth set of TCI states indicated by the second TCI state (de)activation signal comprises a DL/joint TCI state or not, and/or if the fourth set of TCI states comprise at least one DL/joint TCI state, the UE does not keep/maintain/remain the first set of TCI states, and/or if the fourth set of TCI states comprises at least one DL/joint TCI state, the UE could consider to keep/maintain/remain the first set of TCI states (which may need other bullet check), or alternatively, no matter if the fourth set of TCI states indicated by the second TCI state (de)activation signal comprises a DL/joint TCI state or not, whether the UE keeps/maintains/remains the first set of TCI states based on any of the above one or more combined bullets.

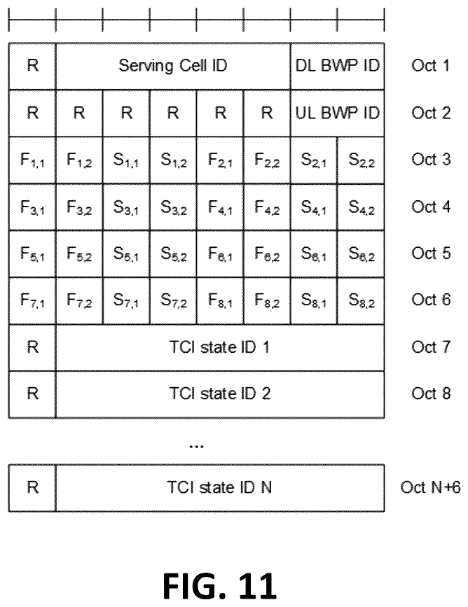

Preferably in certain embodiments, the first set of TCI states corresponds to TCI states associated with F_{i,j} being as value 1 in FIG. 11.

Preferably in certain embodiments, the second set of TCI states corresponds to TCI states associated with S_{i,j} being as value 1 in FIG. 11.

Preferably in certain embodiments, the third set of TCI states corresponds to TCI states associated with F_{i,j} being as value 1 in FIG. 11.

Preferably in certain embodiments, the fourth set of TCI states corresponds to TCI states associated with S_{i,j} being as value 1 in FIG. 11.

Alternatively in certain embodiments, the first set of TCI states corresponds to TCI states associated with F_{i,1} being as value 1 and S_{i,1} being as value 1 in FIG. 11.

Alternatively in certain embodiments, the second set of TCI states corresponds to TCI states associated with F_{i,2} being as value 1 and S_{i,2} being as value 1 in FIG. 11.

Alternatively in certain embodiments, the third set of TCI states corresponds to TCI states associated with F_{i,1} being as value 1 and S_{i,1} being as value 1 in FIG. 11.

Alternatively in certain embodiments, the fourth set of TCI states corresponds to TCI states associated with F_{i,2} being as value 1 and S_{i,2} being as value 1 in FIG. 11.

Preferably in certain embodiments, the fourth set of TCI states corresponds to TCI states associated with all F_{i,2} being as value 0 and at least one S_{i,2} being as value 1 in FIG. 11.

Preferably in certain embodiments, it is possible to switch association between the first/second set of TCI states and F_{i,j}/S_{i,j} in FIG. 11.

Preferably in certain embodiments, the UE may, based on one or more reserved bit fields (e.g., R) in FIG. 11 being as value 1, determine to keep the first set of TCI states being activated.

Preferably in certain embodiments, no matter whether the third set of TCI states indicated by the second TCI state (de)activation signal are the same or different than the first set of TCI states, the UE determines whether to keep the first set of TCI states based on am explicit signaling as provided in the above one or more bullets.

Preferably in certain embodiments, the second TCI state (de)activation signal is in a format of modification. Preferably in certain embodiments, the UE determines an activated one or more TCI states based on a latest TCI state (de)activation signal (without in the format of modification) and one or more TCI state (de)activation signals in a format of modification. Preferably in certain embodiments, the format of modification will be based on one bit of R in FIG. 11. Preferably in certain embodiments, the format of modification will be based on a header (e.g., when the header indicates for modification, a TCI state (de)activation signal is in a format of modification, and/or when the header indicates for new, a TCI state (de)activation signal is to replace whole activated TCI states).

Alternatively and/or preferably in certain embodiments, the first concept could include the aspect of keeping a UL TCI state(s) being activated and/or keeping a UL in mTRP mode when receiving a second TCI state (de)activation signal. Preferably in certain embodiments, based on the second TCI state (de)activation signal, the UE merely changes DL from mTRP mode to sTRP mode (e.g., from TRP2 to TRP3 in FIG. 10). Alternatively and/or preferably in certain embodiments, based on the second TCI state (de)activation signal, the UE merely changes DL from sTRP mode to mTRP mode (e.g., from TRP3 to TRP2 in FIG. 10). Preferably in certain embodiments, the UE would ignore one or more UL TCI states indicated by the second TCI state (de)activation signal (based on the one or more bullets shown above). Preferably in certain embodiments, when the second TCI state (de)activation signal is in a format of modification for sTRP/mTRP operation for one direction e.g., DL or UL, the UE keeps sTRP/mTRP operation for another direction e.g., UL or DL. Preferably in certain embodiments, the second TCI state (de)activation signal could indicate/signal information of whether to keep sTRP/mTRP operation for one direction (e.g., DL or UL). Preferably in certain embodiments, the possibility of the second TCI state (de)activation signal could indicate change in STRP/mTRP operation for both directions, or change sTRP/mTRP operation for one direction (e.g., DL or UL). Preferably in certain embodiments, the signaling method could be based on one or more reserved bits in the second TCI state (de)activation signal or the header of the second TCI state (de)activation or that the DL/joint TCI state(s) indicated by the (e.g., number of DL/joint TCI states and/or TCI state ID(s)) is the same as being indicated by the first TCI state (de)activation signal or that the UL TCI state(s) indicated by the (e.g., number of UL TCI states and/or TCI state ID(s)) is the same as being indicated by the first TCI state (de)activation signal. Preferably in certain embodiments, for DL/joint operation, the UE may determine the number of F_{i,j} being as value 1 in the second TCI state (de)activation signal same as the number of F_{i,j} being as value 1 in the first TCI state (de)activation signal. Preferably in certain embodiments, for UL operation, the UE may determine the number of S_{i,j} being as value 1 in the second TCI state (de)activation signal same as the number of S_{i,j} being as value 1 in the first TCI state (de)activation signal. Preferably in certain embodiments, if the number of F_{i,j} being as value 1 is the same (as the previous signal), the UE keeps the activated TCI state and/or keep sTRP/mTRP operation for DL. Preferably in certain embodiments, if the number of S_{i,j} being as value 1 is the same (as the previous signal), the UE keeps the activated TCI state and/or keep sTRP/mTRP operation for UL.

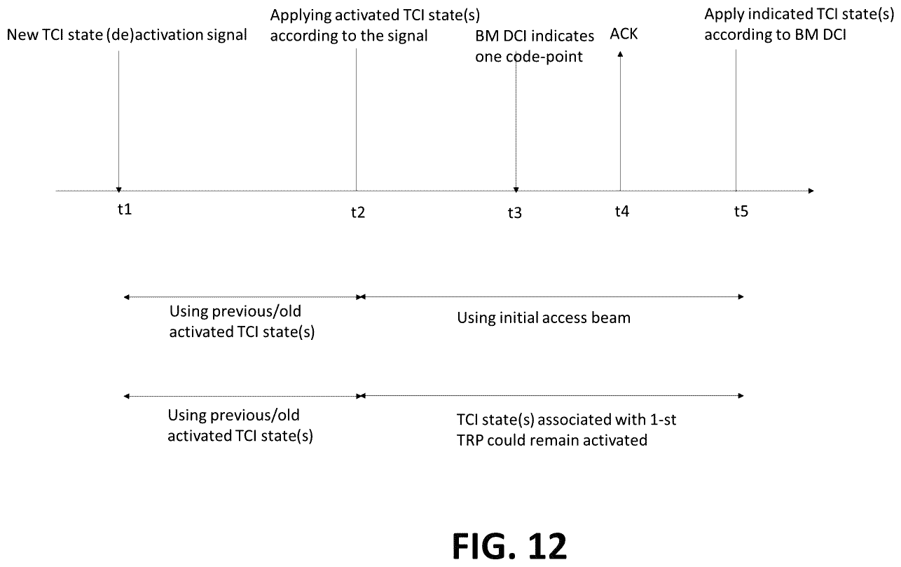

Preferably in certain embodiments, when a specific TCI state is activated and indicated (and applied) before receiving the second TCI state (de)activation signal, if the UE determines to keep the activated specific TCI state (and/or determines NOT to deactivate the specific TCI state), the UE could receive or transmit a channel/signal based on the specific TCI state. In one example, as shown in FIG. 12, t1 corresponds to a timing that the UE receives a new TCI state (de)activation signal, t2 corresponds to a timing that the UE applies the activated TCI state(s) according to the signal, t3 corresponds to a timing that the UE receives a beam management DCI indicating one code-point, t4 corresponds to a timing that the UE transmits Acknowledgement (ACK) in response to the Broadcast Message (BM) DCI, and/or t5 corresponds to a timing that the UE applies indicating TCI state(s) according to the code-point indicated by the BM DCI in t3. Preferably in certain embodiments, assuming the specific TCI state is an activated and indicated TCI state before t1, once the UE determines that the signal received in t1 does not impact on the specific TCI state from activated to deactivated, the UE could determine the specific TCI state as activated (and indicated) at least during a time interval during t2 to t5. In other words, the UE could at least determine without waiting till t5 to use the specific TCI state. This may be due to the “first set of TCI states” is without being deactivated or without having impact in response to receiving the signal in t1. Preferably in certain embodiments, if the specific TCI state is deactivated in response to the signal received in t1 or the specific TCI state has been impacted due to the signal received in t1, the UE would deactivate the specific TCI state and/or receive/transmit the channel/signal during t2 to t5 based on the initial access beam or the spatial relation associated with a Random Access Channel (RACH) procedure (e.g., Contention Based Random Access (CBRA), a Contention Free Random Access (CFRA), a Physical Downlink Control Channel (PDCCH) order triggered RACH, and/or a RACH initiated by the UE).

Preferably in certain embodiments, both the first TCI state (de)activation signal and the second TCI state (de)activation signal are for or are associated with one serving cell. Preferably in certain embodiments, both the first TCI state (de)activation signal and the second TCI state (de)activation signal are for or are associated with one set of serving cells. Preferably in certain embodiments, the one set of serving cells are configured to update TCI states based on one TCI state (de)activation signal. Preferably in certain embodiments, the UE determines the one set of serving cells based on a TCI simultaneous update configuration. Preferably in certain embodiments, the TCI simultaneous update configuration corresponds to any of simultaneousU-TCI-UpdateList1, simultaneousU-TCI-UpdateList2, simultaneousU-TCI-UpdateList3, simultaneousU-TCI-UpdateList4, simultaneousTCI-UpdateList1, or simultaneousTCI-UpdateList2.

A second concept is that the UE determines whether to communicate with at least a UL-only TRP or a TRP with reduced DL functionality (or whether to apply a PL offset for UL transmission to a UL-only TRP or a TRP with reduced DL functionality) based on any one or any combination of the following bullets:
In response to a specific signal (e.g., the specific signal indicates to activate operation of a UL-only TRP or a TRP with reduced DL functionality or the specific signal indicates to apply a PL offset or to activate one or more PL offsets) and preferably the specific signal/indication could be a Radio Resource Control (RRC) reconfiguration message (which may at least associate with the PL offset), a TCI state (de)activation signal, a scheduling DCI, or a BM DCI; and/or
In response to a TCI state (de)activation signal with modification format; and/or
In response to an indication (e.g., one or more bit fields to indicate a UL-only TRP or a TRP with reduced DL functionality) in a TCI state (de)activation signal (i.e., this is an explicit way to indicate the UL-only TRP or the TRP with reduced DL functionality), and preferably the indication is within a TCI state (de)activation signal or a BM DCI or an RRC (re) configuration message; and/or
In response to a TCI state (de)activation signal with F_{i, 2} as all zeros (e.g., FIG. 11) (i.e., this is an implicit way to indicate the UL-only TRP or the TRP with reduced DL functionality); and/or
In response to a TCI state (de)activation signal comprising a TCI state associated with a PL offset value (e.g., a PL offset with a non-zero value or a PL offset is present in the TCI state or a PL offset is present in a PL RS associated with a TCI state); and/or
In response to a BM DCI indicating a code-point associated with a TCI state associated with a PL offset value (e.g., a PL offset with a non-zero value or a PL offset is present in the TCI state or a PL offset is present in a PL RS associated with a TCI state).

### Scheduling DCI Indicating Something

Preferably in certain embodiments, UE determines whether to apply a PL offset based on at least scheduling/activating the DCI's indication. Preferably in certain embodiments, the scheduling/activating DCI comprises one or more bit fields associated with the (applying) PL offset. Preferably in certain embodiments, the one or more bit fields are used to signal the PL offset related indication (e.g., scheduling/activating the DCI's indication). Preferably in certain embodiments, the one or more bit fields associated with the (applying) PL offset could be one bit indicating whether to apply the PL offset. Preferably in certain embodiments, the one or more bit fields associated with the (applying) PL offset could be more bits indicating information of the PL offset (value). In one example, 3 bits with code-point 000˜111, and one or more code-points correspond to a configured PL offset value e.g., 0 dB (this value is an example but not limited to a must have), . . . , −3 dB, −4 dB, . . . , reserved code-point (i.e., this is an example but not limited to this example). In another example, 3 bits with code-point 000˜111, and one or more code-points correspond to a predefined PL offset e.g., 0 dB (this value is an example but not limited to a must have), . . . , −3 dB, −4 dB, . . . reserved code-point (i.e., this is an example but not limited to this example). Preferably in certain embodiments, when the UE is not configured with the PL offset value but is configured with a UL-only TRP or a TRP with reduced DL functionality, the scheduling/activating DCI comprises the one or more bit fields (for indicating the PL offset value). Preferably in certain embodiments, the one or more bit fields could dynamically indicate a more accurate PL offset value. Preferably in certain embodiments, when the UE is configured with the PL offset value (and is configured with a UL-only TRP or a TRP with reduced DL functionality), the scheduling/activating DCI comprises the one or more bit fields (e.g., especially 1 bit for indicating whether to apply the configured PL offset).

Preferably in certain embodiments, the scheduling DCI could schedule or activate a PUSCH(s) associated with a 1-st TRP and/or a 2-nd TRP. Preferably in certain embodiments, the scheduling DCI could schedule or activate a PUSCH(s) associated with a first SRS resource set and/or a second SRS resource set. Preferably in certain embodiments, both the first SRS resource set and the second SRS resource set are associated with the 1-st TRP and the 2-nd TRP, respectively. Preferably in certain embodiments, the first SRS resource set comprises one or more SRS resources. Preferably in certain embodiments, the second SRS resource set comprises another one or more SRS resources. Preferably in certain embodiments, both the first SRS resource set and the second SRS resource set are associated with a non-codebook based PUSCH transmission. Alternatively in certain embodiments, both the first SRS resource set and the second SRS resource set are associated with a codebook based PUSCH transmission.

Preferably in certain embodiments, the scheduling/activating DCI's indication is applied for a 2-nd TRP or a 2-nd SRS resource set (e.g., 2-nd means SRS resource set with a higher ID among two SRS resource sets associated with a non-codebook based PUSCH/codebook based PUSCH) or a 2-nd UL TCI state (which is an ordering in a TCI code-point). Preferably in certain embodiments, the scheduling/activating DCI's indication is NOT applied for a 1-st TRP or a 1-st SRS resource set (e.g., 1-st means SRS resource set with a lower ID among two SRS resource sets associated with a non-codebook based PUSCH/codebook based PUSCH) or a 1-st UL TCI state (which is an ordering in a TCI code-point). Preferably in certain embodiments, the scheduling/activating DCI could indicate a PUSCH(s) is associated with one or 1-st UL TCI states, a 2-nd UL TCI state, or both a 1-st and 2-nd UL TCI states. Preferably in certain embodiments, when/if the scheduling/activating DCI indicates a 1-st UL TCI state, the UE does not expect that the scheduling/activating DCI indicates to apply a PL offset. Preferably in certain embodiments, when/if the scheduling/activating DCI indicates a 2-nd UL TCI state, the UE could receive the scheduling/activating DCI indicating to apply a PL offset or indicating NOT to apply a PL offset. Preferably in certain embodiments, when/if the scheduling/activating DCI indicates both a 1-st UL TCI state and a 2-nd UL TCI state, the UE could receive the scheduling/activating DCI indicating to apply a PL offset (for determining TX power of) PUSCH(s) associated with the 2-nd UL TCI state or indicating NOT to apply a PL offset (for determining TX power of) PUSCH(s) associated with the 2-nd UL TCI state. Preferably in certain embodiments, the UE ignores a bit field associated with whether to apply the PL offset when the scheduling/activating DCI indicates a 1-st UL TCI state. Preferably in certain embodiments, the scheduling/activating DCI corresponds to DCI format 0_1. Alternatively in certain embodiments, the scheduling/activating DCI corresponds to DCI format 0_1/0_2/0_3.

Alternatively and/or preferably in certain embodiments, the scheduling/activating DCI's indication is applied for both TRPs or both SRS resource sets or both UL TCI states (in a TCI code-point). For example, there is a first one or more bit fields, in the scheduling/activating DCI, associated with the first TRP/first SRS resource set/first UL TCI state, and there is a second one or more, in the scheduling/activating DCI, associated with the second TRP/second SRS resource set/second UL TCI state. Preferably in certain embodiments, the UE expects that at most either one of the first one or more bit fields or the second one or more bit fields indicate to apply the PL offset. Preferably in certain embodiments, the UE expects that at most either one of the first one or more bit fields or the second one or more bit fields indicate the PL offset value (being non-zero). Preferably in certain embodiments, the rationale is to avoid applying both a non-zero PL offset in the UE side for UL transmission.

Preferably in certain embodiments, the PL offset (value) could be (pre-) configured per SRS resource set, per SRS resource, per pathloss RS, per (UL) TCI state, or per TRP.

Preferably in certain embodiments, the UE does not expect to receive one or more UL schemes when the UE applies a PL offset or when the UE is signaled to apply a PL offset. Preferably in certain embodiments, the rationale is to avoid too much different TX power transmission in the UE side. Preferably in certain embodiments, in one example, the UE does not expect to perform Single Transmission across/on Multiple Panels (STxMP), wherein one TRP is associated with the PL offset (being as non-zero) and preferably the PL offset is activated. Preferably in certain embodiments, the UE does not expect to have a simultaneous UL transmission to two TRPs, wherein at least one TRP is associated with the PL offset (being as non-zero) and preferably the PL offset is activated. Preferably in certain embodiments, in another example, the UE does not expect to be configured with PUSCH with Time Division Multiplexing (TDM) repetition via two TRPs (or two TCI states) and applying the PL offset.

Alternatively and/or preferably in certain embodiments, based on whether a PL RS (configuration/information) comprises an enabled/configured/present PL offset value or a PL offset or an Information Element (IE) associated with a PL offset, the UE could determine whether to have the PL offset compensation for TCI state or PL RS (configuration/information).

If/When the TCI state comprises an RS ID associated to PL RS (configuration/information) comprising an enabled/configured/present PL offset value or PL offset (e.g., IE associated with PL offset is present and/or the PL offset value not being as zero), the UE performs the PL offset compensation for the UL transmission associated with the TCI state, and/or determines a pathloss estimate based on the PL RS with an enabled/configured/present PL offset, and/or determines the TX power associated with the TCI state or the PL RS (configuration/information) with an enabled/configured/present PL offset.

If/When the TCI state comprises an RS ID associated to PL RS (configuration/information) without comprising an enabled/configured/present PL offset value or PL offset (e.g., IE associated with PL offset is absent and/or the PL offset value being as zero), the UE does not perform the PL offset compensation for the UL transmission associated with the TCI state, and/or determine a pathloss estimate based on the PL RS without PL offset (or assume PL offset value as zero for determining the TX power associated with the TCI state or the PL RS), and/or determines the TX power associated with the TCI state or the PL RS (configuration/information) without a PL offset (or assumes the PL offset value as zero for determining the TX power associated with the TCI state or the PL RS).

The UE applies an enabled/configured/present/activated PL offset for a pathloss estimate based on the PL RS when/if:
The PL RS comprises a PL offset IE (e.g., present and not zero); and/or
The PL offset is associated with the PL RS associated with a 2-nd UL TCI state (which is a 2-nd UL TCI state associated with a TCI code-point, e.g., i-th TCI code-point) (e.g., S_{i, 2}=1); and/or
An indication in the TCI state (de)activation signal indicates to apply the configured/enabled/present PL offset, if any; and/or
Receiving a/the specific signal to activate the operation of the UL-only TRP or the TRP with reduced DL functionality or the specific signal indicates to apply the PL offset or to activate one or more PL offsets; and/or
TCI state (de)activation signal is in a modification format (e.g., a second format) and preferably when a TCI state (de)activation signal is in a normal format (e.g., a first format), the UE does not apply the enabled/configured/present/activated PL offset for the pathloss estimate based on the PL RS.

Alternatively and/or preferably in certain embodiments, based on whether a (indicated/activated/configure) TCI state (configuration/information) comprises an enabled/configured/present PL offset value or a PL offset or an IE associated with a PL offset, the UE could determine whether to have PL offset compensation for the TCI state (configuration/information).

If/When the TCI state comprises an enabled/configured/present PL offset value or PL offset (e.g., an IE associated with the PL offset is present and/or the PL offset value not being zero), the UE performs a PL offset compensation for the UL transmission associated with the TCI state, and/or determines the pathloss estimate based on at least the enabled/configured/present PL offset, and/or determines the TX power associated with the TCI state with the enabled/configured/present PL offset.

If/When the TCI state comprises or is without an enabled/configured/present PL offset value or PL offset (e.g., an IE associated with the PL offset is absent and/or the PL offset value being zero), the UE does not perform the PL offset compensation for the UL transmission associated with the TCI state, and/or determines the pathloss estimate without being based on the PL offset (or assumes the PL offset value as zero for determining the TX power associated with the TCI state), and/or determines the TX power associated with the TCI state without the PL offset (or assumes the PL offset value as zero for determining the TX power associated with the TCI state or the PL RS).

The UE applies an enabled/configured/present/activated PL offset for pathloss estimate based on a PL RS which is associated with at least one of an indicated, activated, or configured UL TCI state when/if:
The UL TCI state comprises a PL offset IE (e.g., present and not zero); and/or
The PL offset associated with the UL TCI state which is a 2-nd UL TCI state (which is a 2-nd UL TCI state associated with a TCI code-point, e.g., i-th TCI code-point) (e.g., Si, 2=1); and/or
An indication in the TCI state (de)activation signal indicates to apply the configured/enabled/present PL offset, if any; and/or
Receiving a/the specific signal to activate the operation of the UL-only TRP or the TRP with reduced DL functionality or the specific signal indicates to apply the PL offset or to activate one or more PL offsets; and/or
TCI state (de)activation signal is in a modification format (e.g., a second format) and preferably when the TCI state (de)activation signal is in a normal format (e.g., a first format), the UE does not apply the enabled/configured/present/activated PL offset for the pathloss estimate based on the PL RS (e.g., once the UE determines the pathloss estimate based on the PL RS, the UE does not apply the enabled/configured/present/activated PL offset).

Alternatively and/or preferably in certain embodiments, based on whether an SRS resource set comprises the enabled/configured/present PL offset value or the PL offset or the IE associated with PL offset, the UE could determine whether to have PL offset compensation for the UL transmission associated with the SRS resource set. Preferably in certain embodiments, the SRS resource set could be associated with a PUSCH transmission. Preferably in certain embodiments, PUSCH(s) scheduled or configured or activated by a scheduling/activating DCI or an RRC configuration is at least associated with the SRS resource set (e.g., the scheduling/activating DCI indicates one SRS resource in the SRS resource set to associate with PUSCH). Preferably in certain embodiments, the above association could be applying a same set of antenna ports, a same spatial relation. Preferably in certain embodiments, when the scheduling/activating DCI or RRC configuration for PUSCH indicates the SRS resource set comprising the PL offset value (e.g., not being as zero), the UE applies the PL offset value for determining the TX power for the PUSCH. Preferably in certain embodiments, when the scheduling/activating DCI or RRC configuration for PUSCH indicates the SRS resource set without comprising the PL offset value or indicating the PL offset value as zero, the UE does not apply the PL offset value for determining the TX power for the PUSCH or determines the TX power for the PUSCH without applying the PL offset or the UE determines the TX power for PUSCH via assuming the PL offset as zero. Preferably in certain embodiments, when the UE is configured with (at least) a first SRS resource set and a second SRS resource set associated with a non-codebook based PUSCH transmission or codebook based PUSCH transmission, the UE does not expect both the first and the second SRS resource sets are configured with the PL offset. Preferably in certain embodiments, in this case, the UE expects at most one SRS resource set is configured with the PL offset.

Preferably in certain embodiments, the PL offset is restricted to be configured in a semi-static (or aperiodic) SRS resource set (e.g., a third SRS resource set). Preferably in certain embodiments, once the third SRS resource set is activated, the UE would determine the TX power based on the PL offset. Preferably in certain embodiments, once the third SRS resource set is activated and the UE is indicated to perform PUSCH(s) associated with the third SRS resource set, the UE would determine the TX power for the PUSCH(s) based on at least the PL offset. Preferably in certain embodiments, once the third SRS resource set is deactivated, the UE would determine the TX power without being based on the PL offset or determines the TX power via assuming the PL offset being as zero.

Preferably in certain embodiments, “SRS resource set” could be replaced by “SRS resource”. Preferably in certain embodiments, the UE could receive a different PL offset value associated with an SRS resource in one SRS resource set. Preferably in certain embodiments, the UE could receive a different presence/absence of IE of the PL offset associated with the SRS resource in one SRS resource set. Preferably in certain embodiments, based on the SRS resource indicated by the scheduling/activating DCI or RRC configuration for PUSCH, the UE could determine whether to apply the PL offset (and its PL offset value) for determining the TX power for PUSCH. Preferably in certain embodiments, the UE does not expect to receive a configuration with a first SRS resource with PL offset presence and a second SRS resource with PL offset absence. Preferably in certain embodiments, both the first SRS resource and the second SRS resource are configured in a same SRS resource set. Preferably in certain embodiments, the SRS resource set is associated with a UL-only TRP. Preferably in certain embodiments, the scheduling/activating DCI or RRC configuration is used to indicate one SRS resource in the SRS resource set.

Preferably in certain embodiments, “SRS resource set” could be replaced by “closed loop index”. Preferably in certain embodiments, the UE could be configured with or activated with association between a 1-st/2-nd closed loop index (associated with SRS) with a 1-st/2-nd SRS resource set. Preferably in certain embodiments, based on the association between a closed loop index (associated with SRS) and the SRS resource set, when the scheduling/activating DCI or RRC configuration indicates one SRS resource set, the UE could determine the “closed loop index” (associated with SRS). Preferably in certain embodiments, the PL offset could be configured per closed loop index (associated with SRS).

Throughout the present disclosure, a PL offset configured in a “target” could be configured via a PL offset ID which is associated with a PL offset, or configured via a value (directly).

Preferably in certain embodiments, a lower layer signal could indicate at least one of one or more PL offset values, and/or whether to apply a PL offset for at least one of one or more (UL) TCI states, one or more SRS resources, and/or one or more SRS resource sets. Preferably in certain embodiments, once the UE receives the lower layer signal (and applies the lower layer signal), the UE determines whether to apply a PL offset for a corresponding target (e.g., the at least one of one or more (UL) TCI states, one or more SRS resources, and/or one or more SRS resource sets) based on the lower layer signal (e.g., based on the indication of the lower layer signal). Preferably in certain embodiments, once the UE receives the lower layer signal (and applies the lower layer signal), the UE determines one or more applied PL offset values for the corresponding target (e.g., the at least one of one or more (UL) TCI states, one or more SRS resources, one or more SRS resource sets) based on the lower layer signal (e.g., based on the indication of the lower layer signal). Preferably in certain embodiments, the lower layer signal could be a MAC CE, or a DCI. Preferably in certain embodiments, the lower layer signal could be the same or a different MAC CE as a TCI state (de)activation signal. For example, a bit-map in FIG. 11 indicates one or more 2-nd UL TCI states in a TCI code-point whether to apply a PL offset, respectively (e.g., a new added octet indicating up to an 8 code-point whether to apply the PL offset). For another example, one bit in FIG. 11 (which may reuse on R) to indicate whether to apply a PL offset for all 2-nd UL TCI states in TCI code-points. For third example, a number of bits in FIG. 11 are used to indicate a PL offset being associated with all or one or more 2-nd UL TCI states in a TCI code-point. For a fourth example, a newly added bit-map (e.g., a number of bits indicating a PL offset value to associate with one 2-nd UL TCI state in a TCI code-point, respectively) is used to indicate a PL offset value being associated with one or more 2-nd UL TCI states in the TCI code-point. Above examples are assuming using a same MAC CE as a TCI state (de)activation signal. An alternative example could be this structure is in a different MAC CE or a DCI than a TCI state (de)activation signal. Preferably in certain embodiments, applying timing may be the same as the TCI state (de)activation signal. Preferably in certain embodiments, when the UE receives the lower layer signal in a first timing, the UE applies an (updated/changed/activated/indicated) PL offset at a second timing. Preferably in certain embodiments, the UE may transmit or report Hybrid Automatic Repeat Request (HARQ) information in response to the lower layer signal at a third timing. Preferably in certain embodiments, the third timing is with a second time offset with respect to the first timing. Preferably in certain embodiments, the second timing could be with a third offset with respect to the third timing. Preferably in certain embodiments, in time domain, the order could be the first timing followed by the third timing, followed by the second timing. Preferably in certain embodiments, the second timing could have a first time offset than the first timing. Preferably in certain embodiments, the first time offset is used for processing the lower layer signal. Preferably in certain embodiments, the second time offset is used for processing the lower layer signal. Preferably in certain embodiments, the second time offset is used for preparing/updating/changing/activating. Preferably in certain embodiments, the second time offset is used for updating/changing/activating based on the lower layer signal. Preferably in certain embodiments, before the lower layer signal, the UE receives a higher layer signal (e.g., an RRC signal and/or RRC reconfiguration) for configuring the PL offset value and/or configure to apply the PL offset for one or more targets (e.g., target corresponds to SRS resource set, SRS resource, (UL) TCI state), ul-power control). Preferably in certain embodiments, the lower layer signal is used to update or replace or modify the PL offset associated with one or more targets configured by the higher layer signal. Preferably in certain embodiments, the higher layer may not configure the PL offset value (and merely configure the UE with a mechanism of PL offset or UL-only TRP mode or TRP with reduced functionality).

Preferably in certain embodiments, in response to (indication of) the lower layer signal, the UE could determine one or more PL offsets (values) (for corresponding one or more targets).

Preferably in certain embodiments, in response to (indication of) the lower layer signal, the UE could determine to update/change/replace/activate one or more PL offsets (values) (for corresponding one or more targets).

Preferably in certain embodiments, in response to (indication of) the lower layer signal, the UE could determine whether to apply the PL offset.

Preferably in certain embodiments, in response to (indication of) the lower layer signal, the UE could determine to deactivate a previous one or more PL offsets (values) (for corresponding one or more targets).

Preferably in certain embodiments, the previous one or more PL offsets (values) may correspond to one or more PL offsets (values) configured by the higher layer or correspond to one or more PL offsets (values) indicated/signaled by the previous lower layer signal. Preferably in certain embodiments, partial replacement/update of the PL offset, or full replacement/update of the PL offset could be applied for a (newly) received lower layer signal. For example, one or more PL offset values according to a previous signal (e.g., the higher layer signal or previous lower layer signal) could be {A, B, C}, the (newly) lower layer signal indicates {D, E, F} and then this is for full replacement. Preferably in certain embodiments, the UE determines the PL offset from {A, B, C} to {D, E, F}. For another example, when the (newly) lower layer signal indicates {D, E}, the UE may determine to replace A by D and replace B by E. Preferably in certain embodiments, the UE would deactivate or not apply the PL offset for the target associated with C. Preferably in certain embodiments, the UE would keep applying the PL offset for the target associated with C. Preferably in certain embodiments, the (newly) received lower layer signal could indicate which PL offset is updated or replaced or modified. Preferably in certain embodiments, for the PL offset NOT indicated by the (newly) received lower layer signal, the UE could keep to apply or alternatively the UE would deactivate (autonomously). Preferably in certain embodiments, and/or additionally, based on the lower layer signal, the UE could determine whether to apply the PL offset (and corresponding PL offset value) for determining the TX power for PUCCH (e.g., carrying Uplink Control Information (UCI) such as HARQ, Scheduling Request (SR), CSI), PUSCH (e.g., dynamic grant or configured grant), SRS (configured with the following unified TCI state) or SRS (not configured with the following unified TCI state).

Preferably in certain embodiments, the UE could have two types of lower layer signal. Preferably in certain embodiments, a first type of the two types of lower layer signal is used to indicate the PL offset related information for the UL channel/signal following the unified TCI state (e.g., PUCCH, PUSCH, SRS configured to follow the unified TCI state). Preferably in certain embodiments, a second type of the two types of lower layer signal is used to indicate a PL offset related information for the UL channel/signal not following the unified TCI state. Throughout the present disclosure, “a channel/signal NOT following the unified TCI state” corresponds that the UE receives/transmits the channel/signal based on one or more indicated TCI states according to a (BM) DCI. Throughout the present disclosure, “unified TCI state” could be replaced by “enhanced unified TCI state”. Preferably in certain embodiments, for the UL channel/signal not following the unified TCI state (e.g., SRS not configured to following unified TCI state), an SRS resource or SRS resource set could be configured with a corresponding/distinct/independent (UL) TCI state. Preferably in certain embodiments, the corresponding/distinct/independent (UL) TCI state could be configured with a PL offset and preferably ul-power control (information). Preferably in certain embodiments, the first type of the two types of lower layer signal is used to indicate PL offset related information for the unified TCI state indicated by the BM DCI. Preferably in certain embodiments, the second type of the two types of lower layer signal is used to indicate a PL offset related information for the TCI state configured for the corresponding UL channel/signal (which are configured to not follow the unified TCI state). Preferably in certain embodiments, then, the first type of the two types of lower layer signal could be as part of an indication in the TCI state (de)activation signal (e.g., TCI state (de)activation signal could indicate the PL offset related information comprising at least one or whether to apply the PL offset or one or more PL offsets for one or more targets). Preferably in certain embodiments, the second type of the two types of lower layer signal could be additionally to the TCI state (de)activation signal. Alternatively in certain embodiments, one mechanism or one type of the lower layer signal could be a unified solution for indicating the PL offset related information. Preferably in certain embodiments, no matter whether the UL channel/signal is configured with the following unified TCI state or not, the UE determines the PL offset related information based on the one type of lower layer signal. Preferably in certain embodiments, the UE may need to combine (i) the TCI state (de)activation signal and (ii) the lower layer signal to determine the TX power and/or determine the pathloss estimate for the UL channel/signal following the unified TCI state (when the UE is configured with UL-only TRP mode or TRP with reduced DL functionality). Preferably in certain embodiments, the UE may need to combine (i) the RRC signal for the UL channel/signal that are not configured to follow the unified TCI state and (ii) the lower layer signal to determine the TX power and/or determine the pathloss estimate for the UL channels/signals that are not configured to follow the unified TCI state (when the UE is configured with UL-only TRP mode or TRP with reduced DL functionality). Preferably in certain embodiments, the UE could receive the TCI state (de)activation signal indicating the PL offset related information (e.g., whether to apply one or more PL offset values), Alternatively and/or preferably in certain embodiments, once the lower layer signal (or TCI state (de)activation signal) indicates to apply the PL offset, the UE would apply the PL offset for determining the TX power or the pathloss estimate for a specific set of UL channels/signals. Preferably in certain embodiments, the specific set of UL channels/signals comprise a UL channel/signal associated with the (UL) TCI state or target that is signaled/indicated to apply the PL offset by the lower layer signal. For example, when the lower layer signal or TCI state (de)activation signal indicates to apply the PL offset for a 2-nd TRP or a 2-nd (UL/joint) TCI state, the UE determines to apply the PL offset for determining the TX power or the pathloss estimate associated with the UL channel/signal associated with the 2-nd TRP or the 2-nd (UL/joint)

TCI state. Preferably in certain embodiments, even when a UL channel/signal is not following the unified TCI state, if the UL channel/signal is configured or associated with the corresponding target (e.g., n-th TRP or n-th TCI state, n corresponds to either first or second) which the corresponding target is indicated/signaled to apply the PL offset or with an applied PL offset value, the UE would determine to apply the PL offset for determining the TX power or pathloss estimate based on the PL offset.

Preferably in certain embodiments, the lower layer signal could be used to update a pathloss reference RS for an SRS resource (set) (e.g., SRS Pathloss Reference RS Update MAC CE).

Preferably in certain embodiments, the lower layer signal could be used to indicate the spatial relation info of SRS resource of one or more Serving Cells (e.g., Serving Cell Set based SRS TCI State Indication MAC CE).

Preferably in certain embodiments, the lower layer signal could be used to update a mapping between PUSCH Pathloss Reference RS (ID(s)) and SRI PUSCH power control (ID(s)) (e.g., PUSCH Pathloss Reference RS Update MAC CE).

Preferably in certain embodiments, the UE could be configured with a specific SRS resource set. Preferably in certain embodiments, the specific SRS resource set is configured with NOT following the unified TCI state. Preferably in certain embodiments, the specific SRS resource set comprises a plurality of SRS resources. Preferably in certain embodiments, each SRS resource of the plurality of SRS resources could be configured with a corresponding (UL) TCI state. Preferably in certain embodiments, the UE would transmit each SRS resource of the plurality of SRS resources based on at least a corresponding (UL) TCI state. Preferably in certain embodiments, the UE may determine whether to apply the PL offset based on at least a higher layer signal and/or a lower layer signal. Preferably in certain embodiments, based on at least or when the higher layer signal indicating to apply the PL offset (or operating in UL-only TRP mode or TRP with reduced DL functionality) and/or a lower layer signal indicating the PL offset related information, the UE could determine to apply the PL offset for one or more targets. Preferably in certain embodiments, based on at least or when the higher layer signal indicates to NOT apply the PL offset (or PL offset value as zero or not configured or absent) and/or (without receiving) the lower layer signal indicating to not apply the PL offset (or no signaling PL offset), the UE may determine NOT to apply the PL offset. Preferably in certain embodiments, (even) based on at least or when the higher layer signal indicates to operate in UL-only TRP mode or TRP with reduced DL functionality and without receiving the lower layer signal, the UE may determine NOT to apply the PL offset. Preferably in certain embodiments, (even) based on at least or when the higher layer signal indicates a PL offset value and without receiving the lower layer signal to activate or signal to apply, the UE may determine NOT to apply the PL offset.

Preferably in certain embodiments, for the specific SRS resource set, the UE determines whether to apply a PL offset based on whether the (UL) TCI state, which is associated with or configured to an SRS resource with a lowest SRS resource ID (e.g., SRS-ResourceId) in the specific SRS resource set, is associated with the PL offset or not. Preferably in certain embodiments, the specific SRS resource set comprises (at least) a first SRS resource and a second SRS resource, wherein the first SRS resource is configured with the lowest SRS resource ID while the second SRS resource is configured with the SRS resource ID higher than the first SRS resource. Preferably in certain embodiments, the UE determines whether to apply the PL offset for the first and/or the second SRS resource in the specific SRS resource set based on whether the (UL) TCI state or PL RS associated with the (UL) TCI state, associated with the first SRS resource, is configured with or associated with the PL offset or is applying the PL offset or not. Preferably in certain embodiments, when the (UL) TCI state for the first SRS resource is associated with applying the PL offset or with the present PL offset, the UE applies the PL offset for the TX power determination for all SRS resources in the specific SRS resource set or the UE applies the PL offset for the TX power determination for the first and the second SRS resource in the specific SRS resource set.

Preferably in certain embodiments, when the UE receives the lower layer signal to update/change/activate/replace/modify one or more PL offsets, and the lower layer signal indicates the TCI state or PL RS associated with the first SRS resource in the specific SRS resource set, the UE updates/changes/activates/replaces/modifies the PL offset associated with the first SRS resource. Preferably in certain embodiments, based on the lower layer signal, the PL offset associated with the TCI state or PL RS associated with the first SRS resource is updated (e.g., updated from x dB to y dB). Preferably in certain embodiments, based on the lower layer signal, the UE determines the TX power associated with the first SRS resource and/or the second resource and/or all SRS resources in the specific SRS resource set based on an (updated) PL offset.

Preferably in certain embodiments, the lower layer signal could be a MAC CE or DCI. Preferably in certain embodiments, the lower layer signal could indicate association between the PL offset (value) and one or more targets. Preferably in certain embodiments, the lower layer signal could indicate one PL offset (value) associated with one (UL) TCI state, one PL RS, one SRS resource, one SRS resource set, or one TRP (could be replaced by CORESETPoolIndex). Preferably in certain embodiments, the lower layer signal could indicate more than one association between one PL offset (value) and one (UL) TCI state, one PL RS, one SRS resource, one SRS resource set, or one TRP (could be replaced by CORESETPoolIndex). For example, the lower layer signal could indicate {PL offset value1, UL TCI state 1}, {PL offset value2, UL TCI state 2}. For another example, the lower layer signal could indicate {PL offset value1, PL RS 1}, {PL offset value2, PL RS 2}. Preferably in certain embodiments, the lower layer signal could indicate a PL RS for one or more serving cells (which is in intra-band). Preferably in certain embodiments, the PL RS or UL TCI state or SRS resource or SRS resource set or TRP could be indicated or signaled by the lower layer signal.

Alternatively in certain embodiments, for the specific SRS resource set, the UE determines whether to apply the PL offset based on a corresponding (configured) (UL) TCI state, which is associated with or configured to an SRS resource, is associated with the PL offset or not. Preferably in certain embodiments, when the (UL) TCI state for the second SRS resource is NOT configured with the PL offset or PL RS associated with the (UL) TCI state, the UE does not apply the PL offset for the TX power determination associated with the second SRS resource.

Preferably in certain embodiments, for an SRS resource set being configured to follow a unified TCI state, the SRS resource set is configured with following the 1-st or 2-nd (UL) TCI state. Preferably in certain embodiments, if/when the SRS resource set is configured to follow a 2-nd TCI state, once the UE determines to apply the PL offset associated with the 2-nd (UL) TCI state, the UE determines to apply the PL offset for the TX power determination or the pathloss estimate for one or more SRS resources in the SRS resource set. Preferably in certain embodiments, the SRS resource set may further comprise a parameter indicating whether to apply the PL offset. Preferably in certain embodiments, the parameter may be present conditioned on following the unified TCI state. Preferably in certain embodiments, based on a purpose of the SRS resource set, the parameter could be configured as not applying the PL offset even if the SRS resource set is configured to follow the unified TCI state and the corresponding unified TCI state may associate with the PL offset. Preferably in certain embodiments, without a loss of generality, the SRS resource set here could be replaced by a configured PUCCH resource or a configured PUSCH (e.g., type-1 Configured Grant (CG) and/or type-2 CG).

Throughout the present disclosure, a joint TCI state means the joint TCI state is used for DL reception and UL transmission.

Throughout the present disclosure, a separate TCI state means a UL TCI state for UL transmission and an another DL TCI state for DL reception.

Preferably in certain embodiments, the UE could receive an indication/signal indicating which PL offset is applied for the pathloss estimate that is associated with either the 1-st or 2-nd UL TCI state (which is an ordering in a TCI code-point). Preferably in certain embodiments, the indication/signal could explicitly indicate a PL offset value. Preferably in certain embodiments, in response to the received indication/signal, the UE applies the PL offset. Preferably in certain embodiments, based on the received indication/signal, the UE determines whether to apply the PL offset for TX power determination. Preferably in certain embodiments, the received indication/signal could be 1 bit indicating information associated with either the 1-st or 2-nd UL TCI state (which is an ordering in a TCI code-point). Preferably in certain embodiments, the UE does not expect to receive indication/signal to indicate both the 1-st and 2-nd UL TCI state. Preferably in certain embodiments, for one TCI code-point or for a pair of activated/indicated TCI states or for mTRP operation with two UL TCI states, the UE does not expect that both UL TCI states are associated with or need to apply the PL offset (e.g., the UE expects only one UL TCI state per TCI code-point needs to apply the PL offset). Alternatively in certain embodiments, the UE could receive indication/signal indicating both the 1-st and 2-nd UL TCI state being needed to apply the PL offset (for determining TX power). Preferably in certain embodiments, when the received indication/signal indicates the 2-nd UL TCI state (which is an ordering in a TCI code-point), the UE applies the PL offset for determining TX power for UL transmission associated with the 2-nd UL TCI state. Preferably in certain embodiments, a timeline of the indication/signal could be based on the latest received indication/signal. Preferably in certain embodiments, in one example, when/in response to receiving an updated indication/signal, the UE could deactivate indication from the previous indication/signal. Alternatively in certain embodiments, the indication/signal could (further) comprise available time duration (e.g., a time duration where the PL offset is applied). Preferably in certain embodiments, after the available time duration, the UE (autonomously) falls back or assumes NOT to apply the PL offset. Preferably in certain embodiments, the starting time for the available time duration is based on timing of the received indication/signal, and/or timing of acknowledgement or response, which is in response to the received indication/signal and preferably with a timing offset (after the timing of acknowledgement or response). Preferably in certain embodiments, the indication/signal is the same as the TCI state (de)activation signal or indication in the TCI state (de)activation signal. Preferably in certain embodiments, no matter whether the indicated TCI code-point is from x-th to y-th, when the UE has received (and applied) an indication/signal indicating applying the PL offset associated with the 2-nd UL TCI state (which is an ordering in a TCI code-point), the UE (always) applies the PL offset for the 2-nd UL TCI state associated with the indicated TCI code-point. Alternatively and/or preferably in certain embodiments, when x-th TCI code-point corresponds to {D1, U1, X, U2} and y-th code-point corresponds to {D3, X, X, U4}, wherein X means no corresponding TCI state and ordering in a TCI code-point corresponds to {1-st DL TCI state, 1-st UL TCI state, 2-nd DL TCI state, 2-nd UL TCI state} (which is an example for illustration but not limited to this ordering), once the UE receives a (BM) DCI indicating code-point from the x-th TCI code-point to y-th code-point, the UE keeps operating in the UL-only TRP or TRP with reduced DL functionality and/or the UE keeps {D, U, X, U} the pattern and updates D1 to D3 and updates U2 to U4. For another example, the x-th code-point corresponds to {D1, U1, X, U2} and the y-th code-point corresponds to {X, U3, X, X}, and when the UE receives the DCI indicating the TCI code-point y-th code-point (e.g., assuming the currently applied indicated TCI code-point is the x-th TCI code-point), the UE keeps {D, U, X, U} pattern and updates U1 to U3. Preferably in certain embodiments, once a received TCI state (de)activation signal indicates one or more TCI code-points comprising/being without the 2-nd DL TCI state, the UE determines that the received TCI state (de)activation signal indicates to enter or activate the UL-only TRP (mode) or TRP with reduced DL functionality (and thus the UE applies the PL offset for the 2-nd UL TCI state). Preferably in certain embodiments, the PL offset granularity could be per PL RS or per UL TCI state or per activated 2-nd UL TCI state (i.e., all activated 2-nd UL TCI states share the same PL offset).

Preferably in certain embodiments, (for scheduling Downlink Control Information (sDCI) based mTRP for UL and sTRP for DL), a possible or candidate TCI state code-point in a TCI state (de)activation signal could be all or a subset of {D1, U1, U2}.

Preferably in certain embodiments, the UE determines whether to enter or activate UL-only TRP (mode) or a TRP with reduced DL functionality based on:
No 2-nd DL TCI state among all TCI code-points in a TCI state (de)activation signal; and/or
At least one TCI code-point comprises a UL TCI state (e.g., preferably in certain embodiments, a 2-nd UL TCI state) which is associated or configured with a PL offset; and/or
A least one TCI code-point comprises a UL TCI state (e.g., preferably in certain embodiments, a 2-nd UL TCI state) comprising a configured PL RS ID pointing/indicating a PL RS which is associated or configured with a PL offset; and/or
Specific indication/signal (which could be the same or different than a TCI state (de)activation signal) to indicate to enter or activate a UL-only TRP (mode) or a TRP with reduced DL functionality; and/or
TCI state (de)activation signal indicates a PL offset value (which is not zero).

Preferably in certain embodiments, the UE could be configured with one or more PL offset (values). Preferably in certain embodiments, the one or more PL offset (values) could be configured with or associated with one PL offset ID. Preferably in certain embodiments, signaling of the PL offset (value) could be based on the PL offset ID. Preferably in certain embodiments, when a specific indication/signal indicates to apply the PL offset or activate the PL offset, the specific indication/signal indicates:
Either a 1-st or 2-nd UL TCI state (e.g., applied PL offset is for TX power determination associated with a 1-st or 2-nd UL TCI state); and/or
PL offset ID (e.g., to indicate a UE to apply which PL offset); and/or
PL RS ID (e.g., to indicate a UE which PL RS is activated and/or indicated and/or to apply a PL offset); and/or
ID of a plurality of PL RSs (e.g., to indicate which one or more PL RSs is activated to apply or associate a PL offset and/or to indicate which one or more PL RSs needs to apply or associate a PL offset); and/or
ID of a plurality of UL TCI states (e.g., to indicate which one or more TCI states is activated to apply or associate a PL offset and/or to indicate which one or more UL TCI states needs to apply or associate a PL offset).

Preferably in certain embodiments, a plurality of PL RSs could be configured based on (grouping) one or more PL RS IDs. Preferably in certain embodiments, a PL RS in the plurality of PL RSs is without comprising an IE associated with the PL offset. Preferably in certain embodiments, the UE, based on the specific signal/indication, determines the PL offset value.

Preferably in certain embodiments, a plurality of PL RSs could be configured based on a configuration of a PL RS (e.g., whether a PL RS comprises IE associated with PL offset). Preferably in certain embodiments, the PL RS in the plurality of PL RSs comprises an IE associated with the PL offset. Preferably in certain embodiments, each PL RS in the plurality of PL RSs could be configured with the (corresponding) PL offset. Preferably in certain embodiments, the UE determines the plurality of PL RSs based on those PL RSs comprising the IE associated with the PL offset. Preferably in certain embodiments, for an n-th PL RS without comprising the IE associated with the PL offset, the n-th PL RS is not included in the plurality of PL RSs.

Preferably in certain embodiments, a plurality of (UL) TCI states could be configured based on (grouping) one or more (UL) TCI state IDs. Preferably in certain embodiments, a (UL) TCI state in the plurality of (UL) TCI states is without comprising the IE associated with PL offset. Preferably in certain embodiments, the UE, based on the specific signal/indication, determines the PL offset value.

Preferably in certain embodiments, a plurality of (UL) TCI states could be configured based on a configuration of the (UL) TCI state (e.g., whether a (UL) TCI state comprises the IE associated with the PL offset). Preferably in certain embodiments, the (UL) TCI state in the plurality of (UL) TCI states comprises the IE associated with the PL offset. Preferably in certain embodiments, each (UL) TCI state in the plurality of (UL) TCI states could be configured with the (corresponding) PL offset. Preferably in certain embodiments, the UE determines the plurality of (UL) TCI states based on those (UL) TCI states comprising the IE associated with the PL offset. Preferably in certain embodiments, for an n-th (UL) TCI state without comprising the IE associated with the PL offset, the n-th (UL) TCI state is not included in the plurality of (UL) TCI states.

Preferably in certain embodiments, the UE could be configured with more than one plurality of PL RSs.

Preferably in certain embodiments, the UE could be configured with more than one plurality of (UL) TCI states.

Throughout the present disclosure, the PL offset is used for determining a PL estimate and/or TX power determination.

Throughout the present disclosure, determining the PL estimate, TX power determination, and Power Headroom Report (PHR) determination could be interchangeable.

Throughout the present disclosure, an ID could be replaced by an index.

Throughout the present disclosure, the UL-only TRP mode or TRP with reduced DL functionality could correspond to the UE communicates with two TRPs, that one TRP is with both DL and UL functionality and the other (or another) TRP is with the UL-only TRP or reduced DL functionality.

Preferably in certain embodiments, when the UE triggers to report a PHR, the UE shall assume the PL offset is zero for determining the (real/virtual) PHR (no matter whether the UE is signaled/indicated to apply the PL offset based on the higher layer signal and/or the lower layer signal).

Alternatively and/or preferably in certain embodiments, when the UE triggers to report the PHR, the UE shall (always) apply the PL offset for determining the (real/virtual) PHR (once the UE is signaled/indicated to apply the PL offset based on the higher layer signal and/or the lower layer signal).

Preferably in certain embodiments, the UE may, based on the lower layer signal or the higher layer signal, determine whether to determine the PHR via using the PL offset. Preferably in certain embodiments, when the higher layer and/or the lower layer signal within indicates to apply the PL offset, the UE determines the (real/virtual) PHR via using the PL offset.

Preferably in certain embodiments, based on either the real or virtual PHR, the UE could determine whether to determine the PHR via using the PL offset. Preferably in certain embodiments, when determining the virtual PHR (for a TRP of a serving cell), the UE assumes there is no PL offset. Preferably in certain embodiments, when determining the real PHR (for the TRP of the serving cell), the UE assumes there is a PL offset and/or the UE applies the PL offset to determine the PHR.

Preferably in certain embodiments, the real PHR means or corresponds that the UE has a configured/scheduled PUSCH for determining the PHR. Preferably in certain embodiments, the virtual PHR means or correspond that the UE does not have a configured/scheduled PUSCH for determining the PHR. Preferably in certain embodiments, the UE would use power control information associated with the configured/scheduled PUSCH for determining the real PHR. Preferably in certain embodiments, the UE would use a default power control information for determining the virtual PHR.

Preferably in certain embodiments, when the UE is configured to operate in UL-only TRP mode or TRP with reduced DL functionality, the default power control information may comprise the PL offset as zero, or a pre-configured PL offset value or lowest (UL) TCI state. Preferably in certain embodiments, when the UE is configured to operate in UL-only TRP mode or TRP with reduced DL functionality, the default power control information DOES NOT comprise the PL offset. Alternatively in certain embodiments, when the UE is NOT configured to operate in UL-only TRP mode or TRP with reduced DL functionality, the default power control information DOES NOT comprise the PL offset.

Preferably in certain embodiments, when the UE is signaled/indicated by the higher layer signal and/or the lower layer signal, the default power control information may comprise the PL offset as zero, or a pre-configured PL offset value or lowest (UL) TCI state. Preferably in certain embodiments, when the UE is signaled/indicated by the higher layer signal and/or the lower layer signal, the default power control information DOES NOT comprise the PL offset. Alternatively in certain embodiments, when the UE is NOT signaled/indicated by the higher layer signal and/or the lower layer signal, the default power control information DOES NOT comprise the PL offset.

Preferably in certain embodiments, based on at least being configured a PL offset (value) for one TRP or one serving cell, the UE reports whether to apply the PL offset for PHR determination for the one TRP in PHR reporting.

Preferably in certain embodiments, based on at least being an activated (and applied) PL offset (value) for one TRP or one serving cell, the UE reports whether to apply the PL offset for PHR determination for the one TRP in PHR reporting.

Preferably in certain embodiments, based on at least being signaled/indicated the PL offset (value) for one TCI state associated with one or more serving cells, the UE reports whether to apply the PL offset for PHR determination for the one TCI state in PHR reporting.

Preferably in certain embodiments, the UE is configured to report two PHRs for one serving cell.

Preferably in certain embodiments, when the UE is configured, for one serving cell (or for a serving cell group), with at least one of PL offset, UL-only TRP operation mode (TRP with reduced DL functionality), to apply PL offset, PL offset value being present, and/or being indicated/signaled to apply the PL offset (by the lower layer signal), the UE does not expect to be configured with two PHR reporting configurations for the one serving cell or for the serving cell group. Preferably in certain embodiments, the UE expects to be configured with no reporting two PHRs for the one serving cell (or for the serving cell group). Preferably in certain embodiments, the UE reports a single PHR for the one serving cell. Preferably in certain embodiments, the single PHR is determined based on a TRP with DL and UL functionality. Alternatively in certain embodiments, the single PHR is determined based on a UL-only TRP or a TRP with reduced DL functionality.

Preferably in certain embodiments, when the UE is configured with reporting two PHRs for one serving cell (or for a serving cell group) which is configured with at least one of PL offset, UL-only TRP operation mode (TRP with reduced DL functionality), to apply PL offset, PL offset value being present, and/or being indicated/signaled to apply the PL offset (by the lower layer signal), the UE could be configured with reporting two PHRs.

Preferably in certain embodiments, when operating in UL-only TRP mode or TRP with reduced DL functionality, the UE assumes the PL offset value as zero for the UL TCI state associated with the TRP with both DL and UL functionality. Preferably in certain embodiments, when receiving a TCI state (de)activation signal (i) comprising at least one TCI code-point with the UL TCI state associated with the PL offset or (ii) indicating to apply or activate the PL offset, (iii) indicating no 2-nd DL TCI state for all TCI code-points or no 1-st DL TCI state for all TCI code-points, and/or (iv) indicating at least one TCI code-point comprises two UL TCI states, the UE assumes to enter or operate or activate in UL-only TRP mode or TRP with reduced DL functionality. Preferably in certain embodiments, when performing in UL-only TRP mode or TRP with reduced DL functionality, the UE applies the PL offset for UL transmission associated with an n-th UL TCI state in a TCI code-point if there is no n-th DL TCI state in all TCI code-points. Preferably in certain embodiments, when performing in UL-only TRP mode or TRP with reduced DL functionality, the UE assumes the PL offset value as zero or does not apply the PL offset for UL transmission associated with an n-th UL TCI state in a TCI code-point if there is at least an n-th DL TCI state in all TCI code-points. Preferably in certain embodiments, no matter if an n-th UL TCI state in a TCI code-point is configured with the PL offset or not, the UE determines whether to apply the PL offset based on a format or indication of the TCI state (de)activation signal.

Preferably in certain embodiments, the UE receives a first TCI state (de)activation signal and applies an indicated one TCI-code-point in the first TCI state (de)activation signal. Preferably in certain embodiments, the UE may operate in UL-only TRP mode or TRP with reduced DL functionality in response to the first TCI state (de)activation signal. Preferably in certain embodiments, the UE may receive a second TCI state (de)activation signal after the timing of receiving the first TCI state (de)activation signal. Preferably in certain embodiments, based on a (modification) format or indication or whether the TCI state comprises the PL offset associated with the second TCI state (de)activation signal, the UE could determine whether to change from UL-only TRP mode or TRP with reduced DL functionality to mTRP mode for both DL and UL. Preferably in certain embodiments, when both the second TCI state (de)activation and the first TCI state (de)activation are associated with UL-only TRP or TRP with reduced DL functionality, the UE activates the TCI state(s) according to the second TCI state (de)activation and/or keeps operating in UL-only TRP mode or TRP with reduced DL functionality.

Preferably in certain embodiments, the PL offset applied time is aligned with timing for applying the TCI state. For example, in FIG. 12, when the UE receives the BM DCI indicating one code-point associated with the TCI state associated with the PL offset, the UE applies the PL offset based on timing t5 (which is the timing that the UE applies the TCI state indicated by the BM DCI).

Preferably in certain embodiments, the UE could be configured with one or more PL offsets (values). Preferably in certain embodiments, when receiving a signal associated with (initial/updating) activating the PL offset at a first timing, the UE applies an (initial/updating) activated PL offset at a second timing. Preferably in certain embodiments, this signal could be an RRC or a MAC CE or a DCI for activation. Preferably in certain embodiments, the signal could be the same as or different than the TCI (de)activation signal. Preferably in certain embodiments, the second timing could be referenced to the first timing. Preferably in certain embodiments, the second timing=the first timing+a processing duration. Preferably in certain embodiments, the second timing corresponds to an earlier/first slot that is after the first timing and a processing duration. Preferably in certain embodiments, after the second timing, the UE applies an (updating) activated PL offset in response to the signal. Preferably in certain embodiments, before the second timing (and the UE has been configured with the PL offset configuration), if there is no previous activated PL offset, the UE assumes the PL offset value as zero.

Preferably in certain embodiments, before receiving the PL offset configuration, the UE assumes no PL offset for determining TX power.

Preferably in certain embodiments, before receiving the PL offset activation, the UE assumes the PL offset value as zero.

In some case, the UE expects to receive a TCI state (de)activation signal with an indication indicating to communicate with a UL-only TRP or TRP with reduced DL functionality and F_{i, 2} are all zeros. Preferably in certain embodiments, the UE does not expect to receive a TCI state (de)activation signal with an indication indicating to communicate with the UL-only TRP or TRP with reduced DL functionality but with at least one F_{i, 2} with value 1 (i.e., this corresponds to a network node restriction that the network node is not allowed to give the UE with such kind of TCI state (de)activation signal). Alternatively in certain embodiments, when the UE receive a TCI state (de)activation signal with an indication indicating to communicate with the UL-only TRP or TRP with reduced DL functionality but with at least one F_{i, 2} with value 1, the UE does not expect to receive the BM DCI indicating code-point associated with the at least one F_{i, 2} with value 1. Alternatively in certain embodiments, when the UE receive a TCI state (de)activation signal with an indication indicating to communicate with the UL-only TRP or TRP with reduced DL functionality but with at least one F_{i, 2} with value 1, the UE determines not to track DL RS associated with the at least one F_{i, 2} with value 1. Alternatively in certain embodiments, when the UE receive a TCI state (de)activation signal with an indication indicating to communicate with the UL-only TRP or TRP with reduced DL functionality but with at least one F_{i, 2} with value 1, the UE drops or withdraws or does not apply the TCI state (de)activation signal or not (de)activate TCI state(s) according to the TCI state (de)activation signal.

Preferably in certain embodiments, the UE determines whether to apply PL offset based on whether the UE receives a signal/indication to apply the PL offset. Preferably in certain embodiments, the PL offset is configured or present or enabled to be associated with a TCI state or PL RS configuration. Preferably in certain embodiments, detailed association of the PL offset could be a PL RS configuration comprising PL offset (presence in PL RS configuration) or the TCI state comprises PL offset (presence in TCI state). Preferably in certain embodiments, the PL offset in the PL RS configuration or TCI state could be based on the PL offset ID or PL offset (value). Preferably in certain embodiments, the PL offset ID corresponds to one PL offset (value). Preferably in certain embodiments, the PL offset (value) could be configured per UL BWP or per serving cell.

Preferably in certain embodiments, when the UE receives a signal/indication to indicate applying PL offset, the UE applies the PL offset configured in a PL RS configuration or in an (activated and/or indicated) TCI state. Preferably in certain embodiments, when the UE does not receive the signal/indication to indicate applying PL offset, the UE does not apply the PL offset.

Preferably in certain embodiments, when the UE applies an indicated TCI state (e.g., after timing t5) and the UE has received a signal/indication to apply PL offset, the UE applies the PL offset associated with the indicated TCI state after timing t5. Preferably in certain embodiments, the signal/indication could be the same as the TCI state (de)activation signal. Preferably in certain embodiments, the signal/indication could be an RRC signal or PDCCH or DCI. For example, the indication for whether to apply the PL offset in a TCI state could be based on BM DCI (which is used to indicate code-point for indicated TCI state(s)). Preferably in certain embodiments, when BM DCI with one bit field to indicate applying PL offset, the UE applies the PL offset in the indicated TCI state (e.g., especially for the 2-nd UL TCI state). Preferably in certain embodiments, when applying the indicated TCI state associated with BM DCI, the UE applies the PL offset when determining pathloss estimate or transmit power. For another example, the indication for whether to apply the PL offset in a TCI state could be based on a scheduling/activating DCI. Preferably in certain embodiments, when the scheduling/activating DCI with one bit field to indicate applying PL offset, the UE applies the PL offset in the indicated TCI state (e.g., especially for the 2-nd UL TCI state). Preferably in certain embodiments, the scheduling DCI at least indicates a UL transmission associated with a 2-nd UL TCI state or a second SRS resource set.

Preferably in certain embodiments, for one or more 1-st TCI states, the UE does not expect to be configured with a TCI state associated with PL offset or PL RS, which is associated with TCI state, being associated with the PL offset. Alternatively in certain embodiments, the UE could receive a TCI state (de)activation signal with one or more 1-st TCI states being associated with PL offset. Preferably in certain embodiments, the UE would expect the PL offset with value 0 for the one or more 1-st TCI states. Preferably in certain embodiments, based on a UL TCI state associated with the 1-st or 2-nd TRP or associated with S_{i,1} or S_{i,2}, the UE would determine whether to apply the PL offset associated with the UL TCI state. Preferably in certain embodiments, for example, when the UL TCI state is associated with the 1-st TRP or associated with S_{i,1}, the UE would determine the pathloss estimate without applying the PL offset associated with the UL TCI state. Preferably in certain embodiments, in a similar example, when the UL TCI state is associated with the 2-nd TRP or associated with S_{i,2}, the UE could determine the pathloss estimate with applying the PL offset associated with the UL TCI state (and preferably may be based on the signal/indication indicating to apply PL offset).

Preferably in certain embodiments, the applied PL offset is only signaled/indicated for one or more 2-nd TCI states in a TCI state (de)activation signal.

Preferably in certain embodiments, the UE determines whether to apply the PL offset for determining the pathloss estimate based on whether the PL offset is configured or present or enabled to be associated with an applied indicated TCI state.

Preferably in certain embodiments, when the PL offset is configured in a PL RS configuration (e.g., present) in an indicated TCI state, the UE applies the PL offset. Preferably in certain embodiments, when the PL offset is NOT configured in the PL RS configuration (e.g., NOT present) (associated with the TCI state), the UE does not apply the PL offset (when applying the TCI state).

Preferably in certain embodiments, when the UE applies an indicated TCI state (e.g., after timing t5), if the TCI state is associated with the PL offset, the UE applies the PL offset. Preferably in certain embodiments, when the UE applies the indicated TCI (e.g., after timing t5), if the TCI state is NOT associated with the PL offset, the UE does not apply the PL offset.

Preferably in certain embodiments, the UE does not expect to receive a TCI state (de)activation signal with at least one 1-st UL TCI state (e.g., a UL TCI state, associated with at least one S_{i,1} which is with value 1, is associated with the PL offset). Preferably in certain embodiments, for one or more 1-st UL TCI states, the UE expects those TCI states to comprise without the PL offset or PL RS associated with those TCI states comprising without the PL offset.

Text proposal 1 (wording in bold and underline). A value for the PL offset is an example but not limited to those values. The PL offset could be an independent information element other than the TCI state. The TCI-UL-State corresponds to the UL TCI state (which is in a separate TCI state mode, and which means it is different than the joint TCI state mode). Alt1 corresponds to directly configuring the PL offset value. Alt2 corresponds to configuring the PL offset ID which is associated with a PL offset value. Alt3 corresponds to configuring applying or the PL offset being present. Based on Alt3, the PL offset value is signaled or indicated by the lower layer signal or another/other higher layer signal.

-- TCI-UL-State
The IE TCI-UL-State indicates the TCI state information for UL transmission.

| | |
|---|---|
| | TCI-UL-State information element |
| TCI-UL-State-r17 ::= | SEQUENCE { |

...

| | |
|---|---|
| (Alt1)PL offset | ENUMERATED {−4dB, −3.5dB, −3dB, −2.5dB, −2dB, −1.5dB, − |

1dB, 0dB} OPTIONAL,

| | |
|---|---|
| (Alt2)PL offset | PL offset-Id OPTIONAL, |
| (Alt3)PL offset | Boolean OPTIONAL, |

}
PL offset {
PL offset-Id PL offset-Id
Value ENUMERATED {−4dB, −3.5dB, −3dB, −2.5dB, −2dB, −1.5dB, −1dB, 0dB}
OPTIONAL,
}

Text proposal 2 (wording in bold and underline). A value for the PL offset is an example but not limited to those values. The PL offset could be an independent information element other than PL RS. Alt1 corresponds to directly configuring the PL offset value. Alt2 corresponds to configuring the PL offset ID which is associated with a PL offset value. Alt3 corresponds to configuring applying or the PL offset being present. Based on Alt3, the PL offset value is signaled or indicated by the lower layer signal or another/other higher layer signal.

-- PathlossReferenceRS
The IE PathlossReferenceRS is used to configure a Reference Signal (e.g., a CSI-RS
config or a SS block) to be used for path loss estimation for PUSCH, PUCCH and SRS
for unified TCI state operation.

PathlossReferenceRS information element

PathlossReferenceRS-r17 ::= SEQUENCE {
...

| | |
|---|---|
| (Alt1)PL offset | ENUMERATED {−4dB, −3.5dB, −3dB, −2.5dB, −2dB, −1.5dB, − |

1dB, 0dB} OPTIONAL,

| | |
|---|---|
| (Alt2)PL offset | PL offset-Id OPTIONAL, |
| (Alt3)PL offset | Boolean OPTIONAL, |

}
PL offset {
PL offset-Id PL offset-Id
Value ENUMERATED {−4dB, −3.5dB, −3dB, −2.5dB, −2dB, −1.5dB, −1dB, 0dB}
OPTIONAL,
}

Text proposal 3 (wording in bold and underline). The condition for the PL RS ID for configuring PL RS associated with a (UL) TCI state is illustrated below. For a (UL) TCI state associated with a UL-only TRP, PL RS could reuse DL RS from PL RS associated with the DL/UL TRP. For example, PL RS for the 2-nd UL TCI state is absent, and PL RS for the 2-nd UL TCI state is determined based on PL RS for the 1-st UL TCI state (e.g., n-th UL TCI state means or corresponds to at least an ordering in a TCI code-point). Preferably in certain embodiments, there is no need to configure PL RS for the 2-nd UL TCI state. Preferably in certain embodiments, whether PL RS for the 2-nd UL TCI state is configured or not is based on whether the UE is configured with the PL offset or not. Preferably in certain embodiments, when the UE is configured with PL offset, the UE could be configured with a UL TCI state without PL RS. Preferably in certain embodiments, the UE expects at least one n-th UL TCI state is configured with a PL RS (and another m-th UL TCI state could be without being configured with PL RS). Preferably in certain embodiments, on the other hand, when the UE is not configured with PL offset, the UE expects each TCI state (associated with one serving cell) is configured with PL RS.

| -- TCI-UL-State | |
|---|---|
| The IE TCI-UL-State indicates the TCI state information for UL transmission. | |
| | TCI-UL-State information element |
| TCI-UL-State-r17 ::= | SEQUENCE { |
| ... | |
| pathlossReferenceRS-Id-r17 | PathlossReferenceRS-Id-r17 |
| OPTIONAL, -- Cond Mandatory | |
| ..., | |
| [[ | |
| tag-Id-ptr-r18 | ENUMERATED {n0,n1} OPTIONAL |

-- Cond 2TA
]]
}
TCI-UL-State field descriptions
...
pathlossReferenceRS-Id
The ID of the reference Signal (e.g., a CSI-RS or a SS block)
used for PUSCH, PUCCH and SRS path loss estimation. This
field refers to an element in the list configured using
pathlossReferenceRSToAddModList in the serving cell
and UL BWP where the UL TCI State is applied by the UE.
...

| Conditional Presence | Explanation |
|---|---|
| 2TA | This field is mandatory present if tag2 is |
| | present for the serving cell. It is absent, |
| | Need R, otherwise. |
| CSI-RSorSRS- | This field is mandatory present if referenceSignal |
| Indicated | is set to csi-RS-index or to srs, absent otherwise |
| Mandatory | The field is mandatory present |
| | if PL offset is not configured. |
| | It is absent, Need S, otherwise. |

Preferably in certain embodiments, for a UL TCI state with any of Text proposal 1, 2, or 3, the UL TCI state corresponds to a UL-only TRP or TRP with reduced DL functionality.

Preferably in certain embodiments, the UE determines whether to apply the PL offset based on whether the PL offset is signaled or indicated in a TCI state (de)activation signal. Preferably in certain embodiments, the UE expects the signal indicates whether to apply the PL offset for the UL transmission associated with the 2-nd UL TCI state of a code-point in the TCI state (de)activation signal. Preferably in certain embodiments, the UE expects that only the 2-nd UL TCI state of a code-point in the TCI state (de)activation signal comprises information of the PL offset. In one example, in FIG. 11, reusing one or more R bits in a TCI state (de)activation signal to signal whether to apply the PL offset for one or more (or all) 2-nd UL TCI states. Once the one or more R bits indicate with a value 1 (or all 1s), the UE would apply the PL offset associated with one or more 2-nd UL TCI states. Preferably in certain embodiments, one or more R bits (directly) signal or indicate the PL offset value for one or more 2-nd UL TCI states. Preferably in certain embodiments, one or more R bits (implicitly) signal or indicate a code-point of the PL offset value for one or more 2-nd UL TCI states. In one example, 000˜111 of 3 R bits corresponds to 8 configured PL offset values (e.g., −1, −2, −3, −4 −5, −6, −7 dB, may comprise 0 dB or reserved code-point). Preferably in certain embodiments, in this example, 000 corresponds to a reserved code-point or 0 dB. Preferably in certain embodiments, the UE determine one or more R bits in a TCI state (de)activation signal being applied for one or more (or all) 1-st UL TCI states or one or more (or all) 2-nd UL TCI states based on whether F_{i,1} is all zeros or F_{i,2} is all zeros. In one example, when F_{i,1} is all zeros (no DL functionality for the 1-st TRP), one or more R bits are applied for one or more (or all) 1-st UL TCI states. In a similar example, when F_{i,2} is all zeros (no DL functionality for the 2-nd TRP), one or more R bits are applied for one or more (or all) 2-nd UL TCI states. Alternatively in certain embodiments, the one or more R bits are only applied for one or more (or all) 2-nd UL TCI states. Preferably in certain embodiments, the UE expects the one or more R bits corresponding to a reserved code-point or value for a TCI state (de)activation with at least one F_{i,2} being as 1 (and at least one F_{i,1} being as 1). Preferably in certain embodiments, the UE does not expect there is not any S_{i,2} being as 1 (e.g., the UE expects mTRP operation for UL or the UE expects at least one S_{i,2} being as 1). Preferably in certain embodiments, when the UE applies the PL offset, the UE expects mTRP operation for UL or the UE expects at least one S_{i,2} being as 1.

Preferably in certain embodiments, a TCI state (de)activation signal could be replaced by PDCCH or (BM) DCI or scheduled/activated DCI.

Throughout the present disclosure, “communicate with UL-only TRP or TRP with reduced DL functionality” could be replaced by “applying PL offset”. Preferably in certain embodiments, the UE may apply the PL offset when the UE operates or is signaled/indicated (or signals/indicates) to communicate with the UL-only TRP or TRP with reduced DL functionality.

Preferably in certain embodiments, the UE is configured with CORESETPoolIndex for at least one CORESET in a serving cell. Preferably in certain embodiments, the UE is configured to operate in mDCI mTRP mode.

Alternatively and/or preferably in certain embodiments, the UE is configured to operate in sDCI mTRP mode.

Various examples and embodiments of the present invention are described below. For the methods, alternatives, concepts, examples, and embodiments detailed above and herein, the following aspects and embodiments are possible.

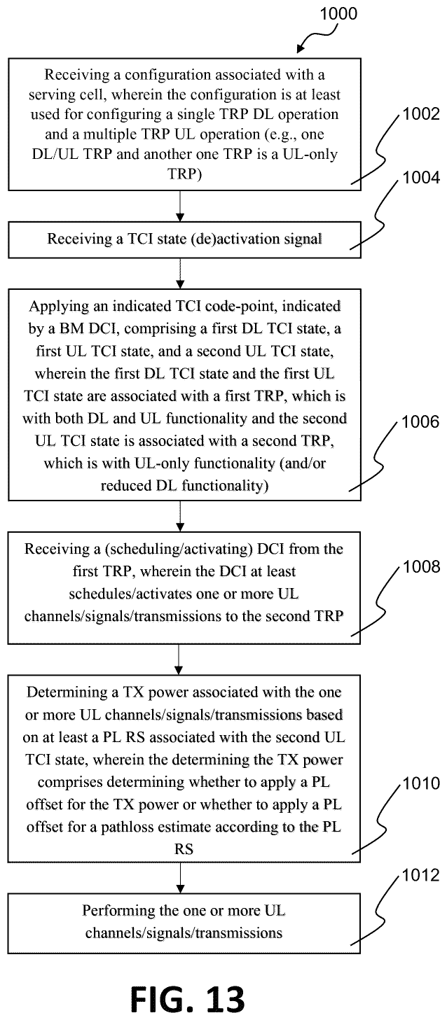

Referring to FIG. 13, with this and other concepts, systems, and methods of the present invention, a method 1000 for a device/UE in a wireless communication system comprises receiving a configuration associated with a serving cell, wherein the configuration is at least used for configuring a single TRP DL operation and a multiple TRP UL operation (e.g., one DL/UL TRP and another one TRP is a UL-only TRP) (step 1002), receiving a TCI state (de)activation signal (step 1004), applying an indicated TCI code-point, indicated by a BM DCI, comprising a first DL TCI state, a first UL TCI state, and a second UL TCI state, wherein the first DL TCI state and the first UL TCI state are associated with a first TRP, which is with both DL and UL functionality and the second UL TCI state is associated with a second TRP, which is with UL-only functionality (and/or reduced DL functionality) (step 1006), receiving a (scheduling/activating) DCI from the first TRP, wherein the DCI at least schedules/activates one or more UL channels/signals/transmissions to the second TRP (step 1008), determining a TX power associated with the one or more UL channels/signals/transmissions based on at least a PL RS associated with the second UL TCI state, wherein the determining the TX power comprises determining whether to apply a PL offset for the TX power or whether to apply a PL offset for a pathloss estimate according to the PL RS (step 1010), and performing the one or more UL channels/signals/transmissions (step 1012).

Preferably in certain embodiments, when the second TCI state is configured with a present PL offset or when the PL RS associated with the second TCI state is configured with the present PL offset, the UE (determines to) apply the configured PL offset.

Preferably in certain embodiments, when the second TCI state is not configured with the PL offset (e.g., the PL offset is absent) or when the PL RS associated with the second TCI state is NOT configured with the PL offset (e.g., the PL offset is absent), the UE (determines to) NOT apply the PL offset or assumes the PL offset as/is zero.

Preferably in certain embodiments, when the TCI state (de)activation signal indicates to apply the PL offset and/or one or more PL RS values, the UE (determines to) apply the configured PL offset or the one or more PL offset values.

Preferably in certain embodiments, when the TCI state (de)activation signal indicates NOT to apply the PL offset and/or NOT signal/indicate one or more PL offset values, the UE (determines to) NOT apply the configured PL offset or assumes the PL offset as/is zero.

Preferably in certain embodiments, when the UE receives a specific signal (in addition to the TCI state (de)activation signal) indicating to apply the PL offset and/or one or more PL RS values, the UE (determines to) apply the configured PL offset or the one or more PL offset values.

Preferably in certain embodiments, when the UE receives a specific signal (in addition to the TCI state (de)activation signal) indicates NOT to apply the PL offset and/or NOT signal/indicate one or more PL offset values, the UE (determines to) NOT apply the configured PL offset or assumes the PL offset as/is zero.

Preferably in certain embodiments, when the BM DCI indicates to apply the PL offset and/or one or more PL RS values, the UE (determines to) apply the configured PL offset or the one or more PL offset values.

Preferably in certain embodiments, when the BM DCI indicates NOT to apply the PL offset and/or NOT signal/indicate one or more PL offset values, the UE (determines to) NOT apply the configured PL offset or assumes the PL offset as/is zero.

Preferably in certain embodiments, when the TCI state (de)activation signal is in a first TCI state combination or in a first format, the UE (determines to) applies the configured PL offset.

Preferably in certain embodiments, when the TCI state (de)activation signal is in a second TCI state combination or in a second format, the UE (determines to) NOT apply the configured PL offset or assumes the PL offset as/is zero.

Preferably in certain embodiments, the first TCI state combination or the first format of the TCI state (de)activation signal corresponds to there is no TCI code-point associated with more than one DL TCI state, and/or there is no TCI code-point associated with second DL TCI states (e.g., F_{i,2}=0, for all i).

Preferably in certain embodiments, the first TCI state combination or the first format of the TCI state (de)activation signal may further correspond that at least a first TCI code-point comprises a first UL TCI state and a second TCI code-point comprises a second UL TCI state, wherein the first TCI code-point and the second TCI code-point could be the same or a different TCI code-point.

Preferably in certain embodiments, the second TCI state combination or the second format of the TCI state (de)activation signal corresponds to there is at least one TCI code-point associated with more than one DL TCI state, and/or there is at least a first TCI code-point associated with the first DL TCI state and at least a second TCI code-point associated with the second DL TCI state.

Preferably in certain embodiments, when at least the TCI state activated by the TCI state (de)activation is configured with a PL offset, the UE (determines to) applies the configured PL offset.

Preferably in certain embodiments, the UE receives a second TCI state (de)activation signal (in later timing).

Preferably in certain embodiments, based on TCI state combination or format of the second TCI state (de)activation signal, the UE determines whether to apply the PL offset.

Preferably in certain embodiments, the UE receives a specific signal to update/change/activate/replace/modify one or more PL offset values.

Preferably in certain embodiments, the specific signal could indicate one or more targets (e.g., PL RS, (UL/joint) TCI state, SRS resource, SRS resource set), and one or more PL offset values.

Preferably in certain embodiments, based on the specific signal's indication, the UE could update/change/activate/replace/modify one or more PL offsets associated with one or more targets.

Preferably in certain embodiments, when the UE previously maintains a set of PL offset values, the specific signal could update/change/activate/replace/modify.

Preferably in certain embodiments, when the specific signal without indicating the PL offset for the second UL TCI state, the UE determines not to apply the PL offset associated with the second UL TCI state or assumes the PL offset as/is zero for TX power determination for UL transmission associated with the second TCI state, and/or the UE deactivates the currently/previously maintained/activated PL offset associated with the second UL TCI state.

Preferably in certain embodiments, when the specific signal without indicating the PL offset for the second UL TCI state, the UE determines to keep the currently maintained/activated/applied PL offset associated with the second UL TCI state for TX power determination for UL transmission associated with the second TCI state.

Preferably in certain embodiments, when the specific signal indicates the PL offset for the second UL TCI state, the UE determines to apply a new indicated PL offset associated with the second UL TCI state for TX power determination for UL transmission associated with the second TCI state.

Preferably in certain embodiments, a higher layer signal for configuring the PL offset could be per (UL) TCI state, per PL RS, per TRP, per SRS resource, or per SRS resource set.

Preferably in certain embodiments, the UE applies the (configured) PL offset in response to the higher layer signal configuring the PL offset.

Preferably in certain embodiments, the UE applies the (configured) PL offset in response to the lower layer signal to activate the PL offset configured in the higher layer.

Preferably in certain embodiments, when the UE is configured with a UL channel/signal which is not following a unified TCI state (e.g., not following BM DCI's indicated TCI state(s)) and the UL channel/signal is configured with a TCI state, the UE determines whether to apply the PL offset associated with the UL channel/signal based on at least whether the configured TCI state is associated with the PL offset or not or whether the configured TCI state is associated with the PL RS being associated with the PL offset or not.

Preferably in certain embodiments, for the UL channel/signal, the UE determines whether to apply the PL offset associated with the UL channel/signal based on an indication of the specific signal or the lower layer signal.

Referring back to FIGS. 3 and 4, in one or more embodiments from the perspective of a device (e.g., a UE, a network node, or a TRP) in a wireless communication system, the device 300 includes a program code 312 stored in memory 310 of the transmitter. The CPU 308 could execute program code 312 to: (i) receive a configuration associated with a serving cell, wherein the configuration is at least used for configuring a single TRP DL operation and a multiple TRP UL operation (e.g., one DL/UL TRP and another one TRP is a UL-only TRP); (ii) receive a TCI state (de)activation signal; (iii) apply an indicated TCI code-point, indicated by a BM DCI, comprising a first DL TCI state, a first UL TCI state, and a second UL TCI state, wherein the first DL TCI state and the first UL TCI state are associated with a first TRP, which is with both DL and UL functionality and the second UL TCI state is associated with a second TRP, which is with UL-only functionality (and/or reduced DL functionality); (iv) receive a (scheduling/activating) DCI from the first TRP, wherein the DCI at least schedules/activates one or more UL channels/signals/transmissions to the second TRP; (v) determine a TX power associated with the one or more UL channels/signals/transmissions based on at least a PL RS associated with the second UL TCI state, wherein the determining the TX power comprises determining whether to apply a PL offset for the TX power or whether to apply a PL offset for a pathloss estimate according to the PL RS; and (vi) perform the one or more UL channels/signals/transmissions. Moreover, the CPU 308 can execute the program code 312 to perform all of the described actions, steps, and methods described above, below, or otherwise herein.

Note that any of the above and herein methods, alternatives, concepts, examples, and embodiments may be combined, in whole or in part, or applied simultaneously or separately.

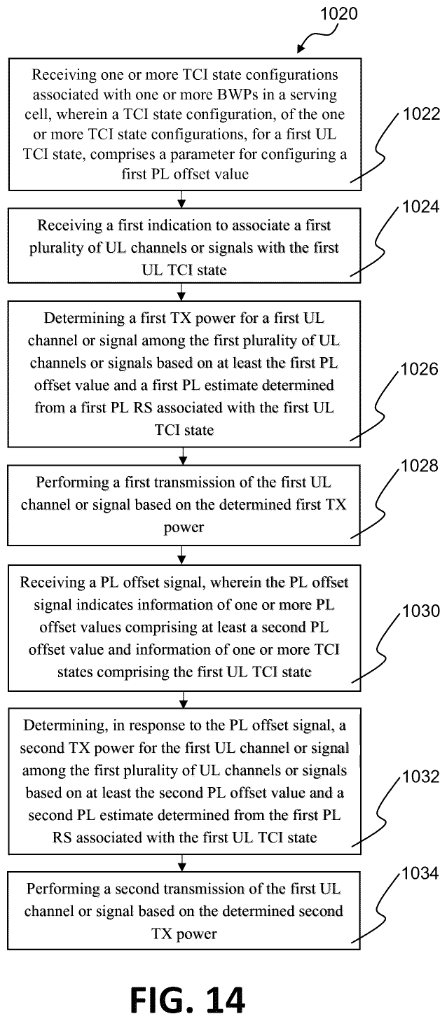

Referring to FIG. 14, with this and other concepts, systems, and methods of the present invention, a method 1020 for a device/UE in a wireless communication system comprises receiving one or more TCI state configurations associated with one or more BWPs in a serving cell, wherein a TCI state configuration, of the one or more TCI state configurations, for a first UL TCI state, comprises a parameter for configuring a first PL offset value (step 1022), receiving a first indication to associate a first plurality of UL channels or signals with the first UL TCI state (step 1024), determining a first TX power for a first UL channel or signal among the first plurality of UL channels or signals based on at least the first PL offset value and a first PL estimate determined from a first PL RS associated with the first UL TCI state (step 1026), performing a first transmission of the first UL channel or signal based on the determined first TX power (step 1028), receiving a PL offset signal, wherein the PL offset signal indicates information of one or more PL offset values comprising at least a second PL offset value and information of one or more TCI states comprising the first UL TCI state (step 1030), determining, in response to the PL offset signal, a second TX power for the first UL channel or signal among the first plurality of UL channels or signals based on at least the second PL offset value and a second PL estimate determined from the first PL RS associated with the first UL TCI state (step 1032), and performing a second transmission of the first UL channel or signal based on the determined second TX power (step 1034).

In various embodiments, the PL offset signal is used to update, change, activate, replace, or modify an original one or more PL offset values for the one or more TCI states, and/or the one or more TCI states correspond to TCI states which are originally configured with a PL offset value or which the parameter for configuring a PL offset value is present, and/or the PL offset signal does not update, change, activate, replace, or modify another one or more TCI states which are originally not configured with a PL offset value or which the parameter for configuring a PL offset value is absent, and/or the information of one or more PL offset values comprises one or more PL offset values, and/or the information of one or more TCI states comprises one or more TCI state IDs, and/or the PL offset signal is a MAC CE, and/or the MAC CE is different than a TCI state activation or deactivation MAC CE, and/or the PL offset signal indicates the information of one or more PL offset values to update, change, activate, replace, or modify the original one or more PL offset values associated with the one or more TCI states.

In various embodiments, before applying the information indicated by the PL offset signal or before receiving the PL offset signal, the UE applies the first PL offset value when determining the first TX power.

In various embodiments, based on the first indication, the UE determines a spatial relation or a UL PC parameter for the first plurality of UL channels or signals based on the first UL TCI state.

In various embodiments, the UE receives a second indication to associate a second plurality of UL channels or signals with a second UL TCI state, and/or the second UL TCI state is configured with a third PL offset value, and/or the third PL offset value is zero.

In various embodiments, before applying the information indicated by the PL offset signal or before receiving the PL offset signal, the UE determines a third TX power for a second UL channel or signal among the second plurality of UL channels or signals based on at least the third PL offset and a third PL estimate determined from a second PL RS associated with the second UL TCI state.

In various embodiments, if the PL offset signal does not indicate to update, change, activate, replace, or modify the third PL offset value, the UE maintains or keeps applying or using the third PL offset value to be associated with the second UL TCI state.

In various embodiments, the UE is configured with a third plurality of UL channels or signals comprising at least a third UL signal and a fourth UL signal, and/or the third UL signal is configured with a lowest resource ID among the third plurality of UL channels or signals, and/or the third plurality of UL channels or signals is not following a unified TCI state, and/or the third UL signal is configured with a third UL TCI state, and/or the third UL TCI state is configured with a fourth PL offset value, and/or when determining a PL offset value for one of the third plurality of UL channels or signals, the UE determines the PL offset value based on a UL TCI state configured for the UL signal in the third plurality of UL channels or signals, wherein the UL signal is with a lowest resource ID among the third plurality of UL channels or signals.

In various embodiments, the UE determines a fourth TX power for the third UL signal among the third plurality of UL channels or signals based on at least a fourth PL estimate, determined from a third PL RS associated with the third UL TCI state, and the fourth PL offset value configured for the third UL TCI state, and/or before applying the information indicated by the PL offset signal or before receiving the PL offset signal, the UE determines a fourth TX power for the third UL signal among the third plurality of UL channels or signals based on at least a fourth PL estimate, determined from a third PL RS associated with the third UL TCI state, and the fourth PL offset value configured for the third UL TCI state.

In various embodiments, the UE determines a fifth TX power for the fourth UL signal among the third plurality of UL channels or signals based on at least a fifth PL estimate, determined from the third PL RS associated with the third UL TCI state, and the fourth PL offset value configured for the third UL TCI state, and/or before applying the information indicated by the PL offset signal or before receiving the PL offset signal, the UE determines a fifth TX power for the fourth UL signal among the third plurality of UL channels or signals based on at least a fifth PL estimate, determined from the third PL RS associated with the third UL TCI state, and the fourth PL offset value configured for the third UL TCI state.

In various embodiments, after applying the information indicated by the PL offset signal or before receiving the PL offset signal, the PL offset signal indicates a fifth PL offset value and the third UL TCI state, and/or the UE determines the fifth PL offset value to be associated with the third UL TCI state, and/or when determining TX power for a UL channel or signal associated with the third UL TCI state, the UE applies the fifth PL offset value.

In various embodiments, the UE receives the one or more TCI state configurations via one or more RRC reconfiguration messages.

In various embodiments, the parameter is per TCI state.

Referring back to FIGS. 3 and 4, in one or more embodiments from the perspective of a device (e.g., a UE, a network node, or a TRP) in a wireless communication system, the device 300 includes a program code 312 stored in memory 310 of the transmitter. The CPU 308 could execute program code 312 to: (i) receive one or more TCI state configurations associated with one or more BWPs in a serving cell, wherein a TCI state configuration, of the one or more TCI state configurations, for a first UL TCI state, comprises a parameter for configuring a first PL offset value; (ii) receive a first indication to associate a first plurality of UL channels or signals with the first UL TCI state; (iii) determine a first TX power for a first UL channel or signal among the first plurality of UL channels or signals based on at least the first PL offset value and a first PL estimate determined from a first PL RS associated with the first UL TCI state; (iv) perform a first transmission of the first UL channel or signal based on the determined first TX power; (v) receive a PL offset signal, wherein the PL offset signal indicates information of one or more PL offset values comprising at least a second PL offset value and information of one or more TCI states comprising the first UL TCI state; (vi) determine, in response to the PL offset signal, a second TX power for the first UL channel or signal among the first plurality of UL channels or signals based on at least the second PL offset value and a second PL estimate determined from the first PL RS associated with the first UL TCI state, and (vii) perform a second transmission of the first UL channel or signal based on the determined second TX power. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving one or more Transmission Configuration Indicator (TCI) state configurations associated with one or more Bandwidth Parts (BWPs) in a serving cell, wherein a TCI state configuration, of the one or more TCI state configurations, for a first Uplink (UL) TCI state, comprises a parameter for configuring a first Pathloss (PL) offset value;
receiving a first indication to associate a first plurality of UL channels or signals with the first UL TCI state;
determining a first Transmit (TX) power for a first UL channel or signal among the first plurality of UL channels or signals based on at least the first PL offset value and a first PL estimate determined from a first Pathloss Reference Signal (PL RS) associated with the first UL TCI state;
performing a first transmission of the first UL channel or signal based on the determined first TX power;
receiving a PL offset signal, wherein the PL offset signal indicates information of one or more PL offset values comprising at least a second PL offset value and information of one or more TCI states comprising the first UL TCI state;
determining, in response to the PL offset signal, a second TX power for the first UL channel or signal among the first plurality of UL channels or signals based on at least the second PL offset value and a second PL estimate determined from the first PL RS associated with the first UL TCI state; and
performing a second transmission of the first UL channel or signal based on the determined second TX power.

2. The method of claim 1, wherein:
the PL offset signal is used to update, change, activate, replace, or modify an original one or more PL offset values for the one or more TCI states, and/or
the one or more TCI states correspond to TCI states which are originally configured with a PL offset value or which the parameter for configuring a PL offset value is present, and/or
the PL offset signal does not update, change, activate, replace, or modify another one or more TCI states which are originally not configured with a PL offset value or which the parameter for configuring a PL offset value is absent, and/or
the information of one or more PL offset values comprises one or more PL offset values, and/or
the information of one or more TCI states comprises one or more TCI state Identities (IDs), and/or
the PL offset signal is a Medium Access Control (MAC) Control Element (CE), and/or
the MAC CE is different than a TCI state activation or deactivation MAC CE, and/or
the PL offset signal indicates the information of one or more PL offset values to update, change, activate, replace, or modify the original one or more PL offset values associated with the one or more TCI states.

3. The method of claim 1, wherein before applying the information indicated by the PL offset signal or before receiving the PL offset signal, the UE applies the first PL offset value when determining the first TX power.

4. The method of claim 1, wherein based on the first indication, the UE determines a spatial relation or a UL Power Control (PC) parameter for the first plurality of UL channels or signals based on the first UL TCI state.

5. The method of claim 1, wherein:
the UE receives a second indication to associate a second plurality of UL channels or signals with a second UL TCI state, and/or
the second UL TCI state is configured with a third PL offset value, and/or
the third PL offset value is zero.

6. The method of claim 5, wherein before applying the information indicated by the PL offset signal or before receiving the PL offset signal, the UE determines a third TX power for a second UL channel or signal among the second plurality of UL channels or signals based on at least the third PL offset and a third PL estimate determined from a second PL RS associated with the second UL TCI state.

7. The method of claim 5, wherein if the PL offset signal does not indicate to update, change, activate, replace, or modify the third PL offset value, the UE maintains or keeps applying or using the third PL offset value to be associated with the second UL TCI state.

8. The method of claim 1, wherein:
the UE is configured with a third plurality of UL channels or signals comprising at least a third UL signal and a fourth UL signal, and/or
the third UL signal is configured with a lowest resource ID among the third plurality of UL channels or signals, and/or
the third plurality of UL channels or signals is not following a unified TCI state, and/or
the third UL signal is configured with a third UL TCI state, and/or
the third UL TCI state is configured with a fourth PL offset value, and/or
when determining a PL offset value for one of the third plurality of UL channels or signals, the UE determines the PL offset value based on a UL TCI state configured for the UL signal in the third plurality of UL channels or signals, wherein the UL signal is with a lowest resource ID among the third plurality of UL channels or signals.

9. The method of claim 8, wherein:
the UE determines a fourth TX power for the third UL signal among the third plurality of UL channels or signals based on at least a fourth PL estimate, determined from a third PL RS associated with the third UL TCI state, and the fourth PL offset value configured for the third UL TCI state, and/or
before applying the information indicated by the PL offset signal or before receiving the PL offset signal, the UE determines a fourth TX power for the third UL signal among the third plurality of UL channels or signals based on at least a fourth PL estimate, determined from a third PL RS associated with the third UL TCI state, and the fourth PL offset value configured for the third UL TCI state.

10. The method of claim 8, wherein:
the UE determines a fifth TX power for the fourth UL signal among the third plurality of UL channels or signals based on at least a fifth PL estimate, determined from the third PL RS associated with the third UL TCI state, and the fourth PL offset value configured for the third UL TCI state, and/or
before applying the information indicated by the PL offset signal or before receiving the PL offset signal, the UE determines a fifth TX power for the fourth UL signal among the third plurality of UL channels or signals based on at least a fifth PL estimate, determined from the third PL RS associated with the third UL TCI state, and the fourth PL offset value configured for the third UL TCI state.

11. The method of claim 8, wherein:
after applying the information indicated by the PL offset signal or before receiving the PL offset signal, the PL offset signal indicates a fifth PL offset value and the third UL TCI state, and/or
the UE determines the fifth PL offset value to be associated with the third UL TCI state, and/or
when determining TX power for a UL channel or signal associated with the third UL TCI state, the UE applies the fifth PL offset value.

12. The method of claim 1, wherein the UE receives the one or more TCI state configurations via one or more Radio Resource Control (RRC) reconfiguration messages.

13. The method of claim 1, wherein the parameter is per TCI state.

14. A User Equipment (UE), comprising:
a memory; and
a processor operatively coupled with the memory, wherein the processor is configured to execute a program code to:
receive one or more Transmission Configuration Indicator (TCI) state configurations associated with one or more Bandwidth Parts (BWPs) in a serving cell, wherein a TCI state configuration, of the one or more TCI state configurations, for a first Uplink (UL) TCI state, comprises a parameter for configuring a first Pathloss (PL) offset value;
receive a first indication to associate a first plurality of UL channels or signals with the first UL TCI state;
determine a first Transmit (TX) power for a first UL channel or signal among the first plurality of UL channels or signals based on at least the first PL offset value and a first PL estimate determined from a first Pathloss Reference Signal (PL RS) associated with the first UL TCI state;
perform a first transmission of the first UL channel or signal based on the determined first TX power;
receive a PL offset signal, wherein the PL offset signal indicates information of one or more PL offset values comprising at least a second PL offset value and information of one or more TCI states comprising the first UL TCI state;
determine, in response to the PL offset signal, a second TX power for the first UL channel or signal among the first plurality of UL channels or signals based on at least the second PL offset value and a second PL estimate determined from the first PL RS associated with the first UL TCI state; and
perform a second transmission of the first UL channel or signal based on the determined second TX power.

15. The UE of claim 14, wherein:
the PL offset signal is used to update, change, activate, replace, or modify an original one or more PL offset values for the one or more TCI states, and/or
the one or more TCI states correspond to TCI states which are originally configured with a PL offset value or which the parameter for configuring a PL offset value is present, and/or
the PL offset signal does not update, change, activate, replace, or modify another one or more TCI states which are originally not configured with a PL offset value or which the parameter for configuring a PL offset value is absent, and/or
the information of one or more PL offset values comprises one or more PL offset values, and/or
the information of one or more TCI states comprises one or more TCI state Identities (IDs), and/or
the PL offset signal is a Medium Access Control (MAC) Control Element (CE), and/or
the MAC CE is different than a TCI state activation or deactivation MAC CE, and/or
the PL offset signal indicates the information of one or more PL offset values to update, change, activate, replace, or modify the original one or more PL offset values associated with the one or more TCI states.

16. The UE of claim 14, wherein before applying the information indicated by the PL offset signal or before receiving the PL offset signal, the UE applies the first PL offset value when determining the first TX power.

17. The UE of claim 14, wherein based on the first indication, the UE determines a spatial relation or a UL Power Control (PC) parameter for the first plurality of UL channels or signals based on the first UL TCI state.

18. The UE of claim 14, wherein:
the UE receives a second indication to associate a second plurality of UL channels or signals with a second UL TCI state, and/or
the second UL TCI state is configured with a third PL offset value, and/or
the third PL offset value is zero.

19. The UE of claim 18, wherein before applying the information indicated by the PL offset signal or before receiving the PL offset signal, the UE determines a third TX power for a second UL channel or signal among the second plurality of UL channels or signals based on at least the third PL offset and a third PL estimate determined from a second PL RS associated with the second UL TCI state.

20. The UE of claim 18, wherein if the PL offset signal does not indicate to update, change, activate, replace, or modify the third PL offset value, the UE maintains or keeps applying or using the third PL offset value to be associated with the second UL TCI state.
